(19) United States
(12) Patent Application Publication
(10) Pub. No.: US 2020/0406815 A1
(43) Pub. Date: Dec. 31, 2020

(54) SYSTEM FOR DETERMINING A LANE FOR A HOST VEHICLE

(71) Applicant: Nissan North America, Inc., Franklin, TN (US)

(72) Inventors: Jeremy CHAMBERS, Casco, MI (US); Roy GOUDY, Farmington Hills, MI (US); Neal PROBERT, Farmington Hills, MI (US)

(21) Appl. No.: 16/452,206

(22) Filed: Jun. 25, 2019

(51) Int. Cl. B60Q 1/50; B60Q 9/00; G08G 1/0967; B60W 30/12; B60W 30/16; G08G 1/0965

(52) U.S. Cl. CPC B60Q 1/50; B60Q 9/008; G08G 1/0965; B60W 30/12; B60W 30/162; G08G 1/096791

(57) ABSTRACT

A system for determining a lane for a vehicle includes a receiver and an electronic controller. The receiver is configured to receive information related to a remote vehicle, the information including a remote vehicle location, a remote vehicle speed and a remote vehicle travel path. The electronic controller is configured to determine a host vehicle location, a host vehicle speed and a host vehicle travel path, compare the host vehicle location with the remote vehicle location, compare the host vehicle speed with the remote vehicle speed and compare the host vehicle travel path with the remote vehicle travel path, and cause the host vehicle to perform a mitigation operation when the electronic controller determines that the remote vehicle location, the remote vehicle speed and the remote vehicle travel path indicate that the remote vehicle must pass or has passed the host vehicle on a right side.

### BACKGROUND

### Field of the Invention

The present invention generally relates to a system for determining a lane for a vehicle. More specifically, the present invention relates to a system for determining a lane for a vehicle based on host vehicle location.

### Background Information

Recently, vehicles are being equipped with a variety of warning and prevention systems such as lane departure and prevention systems, cross traffic alerts, adaptive cruise control, and the like. Further, various informational vehicle-to-vehicle systems have been proposed that use wireless communications between vehicles, and further between vehicle and infrastructures such as roadside units. These wireless communications have a wide range of applications ranging from safety applications to entertainment applications. Also vehicles are sometimes equipped with various types of systems, such as global positioning systems (GPS), which are capable of determining the location of the vehicle and identifying the location of the vehicle on a map for reference by the driver. The type of wireless communications to be used depends on the particular application. Some examples of wireless technologies that are currently available include digital cellular systems, Bluetooth systems, wireless LAN systems and dedicated short range communications (DSRC) systems.

### SUMMARY

It has been discovered that to improve vehicle and vehicle occupant safety, an improved system to determining a lane for a vehicle is desired.

In view of the state of the known technology, one aspect of the present disclosure is to provide a system for determining a lane for a vehicle, the system comprising a receiver and an electronic controller. The receiver is configured to receive information related to a remote vehicle, the information including a remote vehicle location, a remote vehicle speed and a remote vehicle travel path. The electronic controller is configured to determine a host vehicle location, a host vehicle speed and a host vehicle travel path, compare the host vehicle location with the remote vehicle location, compare the host vehicle speed with the remote vehicle speed and compare the host vehicle travel path with the remote vehicle travel path, and cause the host vehicle to perform a mitigation operation when the electronic controller determines that the remote vehicle location, the remote vehicle speed and the remote vehicle travel path indicate that the remote vehicle must pass or has passed the host vehicle on a right side.

Another aspect of the present disclosure is to provide a method for determining a lane for a vehicle. The method comprises operating a receiver to receive information related to a remote vehicle, the information including a remote vehicle location, a remote vehicle speed and a remote vehicle travel path, determining by an electronic controller a host vehicle location, a host vehicle speed and a host vehicle travel path, comparing with the electronic controller the host vehicle location with the remote vehicle location, comparing the host vehicle speed with the remote vehicle speed and comparing the host vehicle travel path with the remote vehicle travel path, and causing with the controller the host vehicle to perform a mitigation operation when the electronic controller determines that the remote vehicle location, the remote vehicle speed and the remote vehicle travel path indicate that the remote vehicle must pass or has passed the host vehicle on a right side.

### BRIEF DESCRIPTION OF THE DRAWINGS

Referring now to the attached drawings which form a part of this original disclosure:

FIG. 1 is a schematic diagram illustrating an example of a host vehicle equipped with a system for determining a lane for a vehicle and components of a global positioning system (GPS);

FIG. 2 is a block diagram of exemplary components of the host vehicle and the remote vehicles that are equipped with the system for determining a lane for a vehicle according to embodiments disclosed herein;

FIG. 3 is a schematic representation of a host vehicle in the left lane with a remote vehicle approaching from the rear;

FIG. 4 is a schematic representation of the host vehicle in FIG. 3 being passed on the right by a remote vehicle and another remote vehicle approaching from the rear;

FIG. 5 is a schematic representation of the host vehicle of FIG. 3 performing a mitigation operation;

FIG. 6 is a schematic representation of a host vehicle in the middle lane with a plurality of remote vehicles approaching from the rear;

FIG. 7 is a schematic representation of the host vehicle in FIG. 6 being passed on the right by a first remote vehicle and a second remote vehicle approaching from the rear and passing on the right;

FIG. 8 is a schematic representation of the host vehicle of FIG. 3 performing a mitigation operation;

FIG. 9 illustrates a step the system for determining a lane for a vehicle of FIG. 2 uses in determination of the remote vehicle position when the remote vehicle is to the northeast of the host vehicle;

FIG. 10 illustrates a step the system for determining a lane for a vehicle of FIG. 2 uses in determination of the remote vehicle position when the remote vehicle is to the northeast of the host vehicle;

FIG. 11 illustrates a step the system for determining a lane for a vehicle of FIG. 2 uses in determination of the remote vehicle position when the remote vehicle is to the northwest of the host vehicle;

FIG. 12 illustrates a step the system for determining a lane for a vehicle of FIG. 2 uses in determination of the remote vehicle position when the remote vehicle is to the northwest of the host vehicle;

FIG. 13 illustrates a step the system for determining a lane for a vehicle of FIG. 2 uses in determination of the remote vehicle position when the remote vehicle is to the southwest of the host vehicle;

FIG. 14 illustrates a step the system for determining a lane for a vehicle of FIG. 2 uses in determination of the remote vehicle position when the remote vehicle is to the southwest of the host vehicle;

FIG. 15 illustrates a step the system for determining a lane for a vehicle of FIG. 2 uses in determination of the remote vehicle position when the remote vehicle is to the southeast of the host vehicle;

FIG. 16 illustrates a step the system for determining a lane for a vehicle of FIG. 2 uses in determination of the remote vehicle position when the remote vehicle is to the southeast of the host vehicle;

FIG. 17 illustrates the maximum remote vehicle heading angle when the remote vehicle is heading the same direction as the host vehicle;

FIG. 18 illustrates the maximum remote vehicle heading angle when the remote vehicle is heading the same direction as the host vehicle;

FIG. 19 illustrates the maximum remote vehicle heading angle when the remote vehicle is heading the same direction as the host vehicle;

FIG. 20 illustrates the maximum remote vehicle heading angle when the remote vehicle is heading the same direction as the host vehicle;

FIG. 21 illustrates the maximum remote vehicle heading angle when the remote vehicle is heading the same direction as the host vehicle;

FIG. 22 illustrates the maximum remote vehicle heading angle when the remote vehicle is heading the same direction as the host vehicle;

FIG. 23 illustrates the maximum remote vehicle heading angle when the remote vehicle is heading the same direction as the host vehicle;

FIG. 24 illustrates the maximum remote vehicle heading angle when the remote vehicle is heading the same direction as the host vehicle;

FIG. 25 illustrates the maximum remote vehicle heading angle when the remote vehicle is heading the same direction as the host vehicle;

FIG. 26 illustrates the maximum remote vehicle heading angle when the remote vehicle is heading the same direction as the host vehicle;

FIG. 27 illustrates the maximum remote vehicle heading angle when the remote vehicle is heading the same direction as the host vehicle;

FIG. 28 illustrates the maximum remote vehicle heading angle when the remote vehicle is heading the same direction as the host vehicle;

FIG. 29 illustrates a situation in which the remote vehicle is considered to be in a crossing path with the host vehicle;

FIG. 30 illustrates a situation in which the remote vehicle is considered to be in a crossing path with the host vehicle;

FIG. 31 illustrates a situation in which the remote vehicle is considered to be in a crossing path with the host vehicle;

FIG. 32 illustrates a situation in which the remote vehicle is considered to be in a crossing path with the host vehicle;

FIG. 33 illustrates a situation in which the remote vehicle is considered to be in a crossing path with the host vehicle;

FIG. 34 illustrates a situation in which the remote vehicle is considered to be in a crossing path with the host vehicle;

FIG. 35 illustrates a situation in which the remote vehicle is considered to be in a crossing path with the host vehicle;

FIG. 36 illustrates a situation in which the remote vehicle is considered to be in a crossing path with the host vehicle;

FIG. 37 illustrates a situation in which the remote vehicle is considered to be in a crossing path with the host vehicle;

FIG. 38 illustrates a situation in which the remote vehicle is considered to be in a crossing path with the host vehicle;

FIG. 39 illustrates a situation in which the remote vehicle is considered to be in a crossing path with the host vehicle;

FIG. 40 illustrates a situation in which the remote vehicle is considered to be in a crossing path with the host vehicle;

FIG. 41 illustrates source data and equation interdependencies; and

FIG. 42 is a flow chart showing the process to determine whether a mitigation operation is necessary.

### DETAILED DESCRIPTION OF EMBODIMENTS

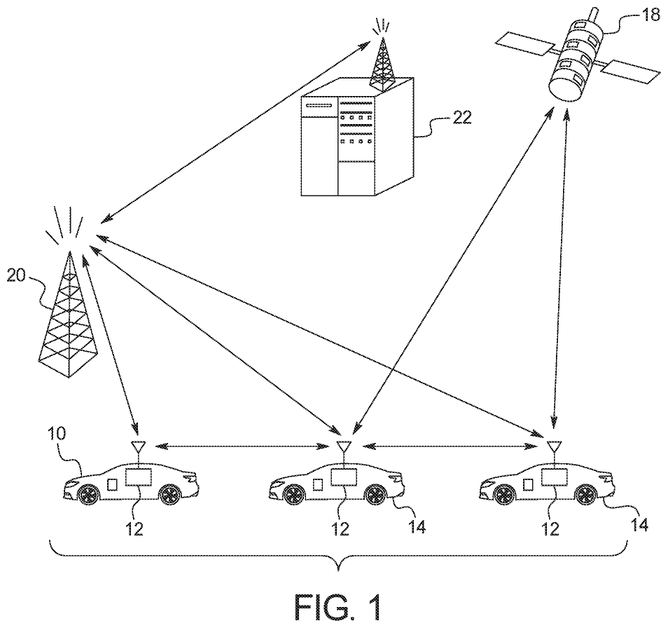

Referring initially to FIG. 1, a two-way wireless communications network is illustrated that includes vehicle to vehicle communication and vehicle to base station communication. In FIG. 1, a host vehicle (HV) 10 is illustrated that is equipped with a system for determining a lane for a vehicle 10 for according to a disclosed embodiment, and a remote vehicle (RV) 14 that can also include the system for determining a lane for a vehicle 12. While the host vehicle 10 and the remote vehicle 14 are illustrated as having the same system 12 for determining a lane for a vehicle, it will be apparent from this disclosure that each of the remote vehicles 14 can include another type of system for determining a lane for a vehicle (or any other system) that is capable of communicating information about at least the location, direction and speed of the remote vehicle 14 relative to the host vehicle 10.

As can be understood, a host vehicle 10 can be traveling along a multilane road 16. When not in the right most lane 16R of the road 16, remote vehicles 14 may undertake (i.e., pass on the right) the host vehicle 10. Depending on the jurisdiction in which the host vehicle 10 is traveling the host vehicle 10 may be required to move to the right (i.e., from the left lane 16L to the right lane 16R) to allow remote vehicles 14 to pass on the left. As one of ordinary skill would understand different states or jurisdictions have different laws and rules. For example, some jurisdictions allow travel in other than the right lane 16R of a multi-lane road 16 any time while others require a vehicle to move to the right lane 16R if they are traveling slower than surrounding traffic. Still others require a vehicle to move to the right lane 16R any time a vehicle is not passing a slower moving vehicle. Alternatively, even when not required by the jurisdiction it may be desirous for the host vehicle 10 to allow remote vehicles 14 to pass on the left.

As one of ordinary skill can understand occupants of the host vehicle 10 may have a limited field of view to discern whether a remote vehicle 14 is approaching. Further, in some situations the remote vehicle 14 may not be visible due to turns in the road, hills along the road, obstacles along the road or any other reasons. The system 12 for determining a lane for a vehicle improves the host vehicle's 10 determination of location, direction and speed of a remote vehicle 14. The system 12 for determining a lane for a vehicle enables the host vehicle 10 or the operator of the host vehicle 10 to determine which lane is the appropriate travel lane.

The system 12 for determining a lane for a vehicle 10 and the remote vehicle 14 communicate with the two-way wireless communications network. As seen in FIG. 1, for example, the two-way wireless communications network can include one or more global positioning satellites 18 (only one shown), and one or more roadside (terrestrial) units 20 (only one shown), and a base station or external server 22. The global positioning satellites 18 and the roadside units 20 send and receive signals to and from the system 12 for determining the number of remote vehicles following a host vehicle of the host vehicle 10 and the remote vehicles 14. The base station 22 sends and receives signals to and from the system 12 for determining the number of remote vehicles following a host vehicle of the host vehicle 10 and the remote vehicles 14 via a network of the roadside units 20, or any other suitable two-way wireless communications network.

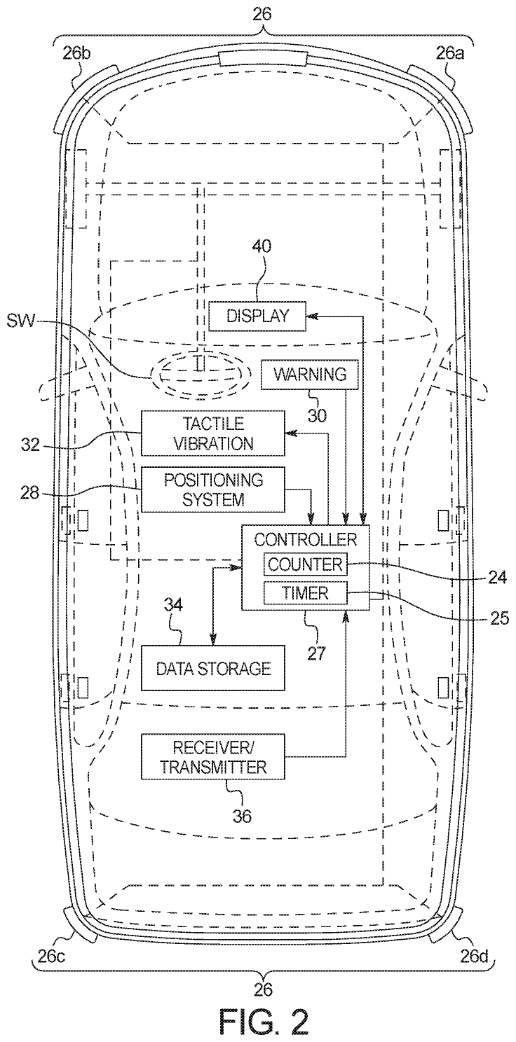

Referring to FIG. 2, a system for determining a lane for a vehicle 10 for a host vehicle 10 is illustrated in accordance with one embodiment. The system 12 includes a controller 24, sensor system (sensors 26a-26d), a positioning system 28, a warning indicator 30 or system, a tactile vibration system 32, data storage 34, and receiver/transmitter system 36. As understood herein, the warning indicator 30, the tactile vibration system 32 and/or an audio alert may act as a mitigation system that alerts the occupant of the host vehicle 10 that the host vehicle 10 is being undertaken by at least one remote vehicle 14 and transitioning to a different lane is appropriate.

The controller 24 is preferably and electronic controller and includes a microcomputer with a control program that controls the system 12 as discussed below. The controller 24 can also include other conventional components such as an input interface circuit, an output interface circuit, and storage device(s) (data storage 34) such as a ROM (Read Only Memory) device and a RAM (Random Access Memory) device. The microcomputer of the controller 24 is programmed to control one or more of the sensor system (sensors 26a-26d), a positioning system 28, a warning indicator 30 or system, a tactile vibration system 32, data storage 34, and the receiver/transmitter system 36, and to make determinations or decisions, as discussed herein. The memory circuit stores processing results and control programs, such as ones for the sensor system (sensors 26a-26d), a positioning system 28, a warning indicator 30 or system, a tactile vibration system 32, data storage 34 and receiver/transmitter system 36 operation that are run by the processor circuit. The controller 24 is operatively coupled to the sensor system (sensors 26a-26d), a positioning system 28, a warning indicator 30 or system, a tactile vibration system 32, data storage 34, and receiver/transmitter system 36 in a conventional manner, as well as other electrical systems in the vehicle 10, such the turn signals, windshield wipers, lights and any other suitable systems. Such a connection enables the controller 24 to monitor and control any of these systems as desired. The internal RAM of the controller 24 stores statuses of operational flags and various control data. The internal ROM of the controller 24 stores the information for various operations. The controller 24 is capable of selectively controlling any of the components of the sensor system (sensors 26a-26d) in accordance with the control program. It will be apparent to those skilled in the art from this disclosure that the precise structure and algorithms for the controller 24 can be any combination of hardware and software that will carry out the functions of the present invention.

As shown in FIG. 2, the controller 24 can include or be in communication with display 40. The controller 24 can further include or be in communication with one or more data storage(s) 34 which can store information as discussed herein. The display 40 enables the controller 24 to provide information and/or feedback concerning the system 12 or any other suitable information. For example, in one embodiment, in addition to or in replacement of the warning indicator 30, the display 40 can display information regarding the remote vehicles 14, the number of remote vehicles 14 and the position of the remote vehicles 14. The display 40 can provide instructions to the operator or occupant of the host vehicle 10 to enable the driver of the host vehicle 10 to perform the appropriate mitigation operation. For example, the display can indicate that transitioning to another lane is appropriate or that the vehicle is in the processing of automatically transitioning to another lane.

In one embodiment, the sensor system (sensors 26a-26d) can include proximity sensors and optical sensors. In one embodiment, the proximity sensors include a plurality of sensors (sensors 26a-26d), and are configured to detect the boundaries 42L and 42R and the center line 42C of the road 16 or other stationary or moving objects (e.g., remote vehicles 14) in proximity to the sensor system (sensors 26a-26d). For example, as illustrated in FIG. 2, front sensors 26a and 26b in the sensor system 26 are preferably mounted externally on the front bumper and rear sensors 26c and 26d are mounted externally on the rear bumper of host vehicle 10. However, the sensors 26a-26d in the sensor system 26 may be mounted on any suitable external portion of the host vehicle 10, including the front and rear quarter panels, the external mirrors or any combination of suitable areas.

The sensor system (sensors 26a-26d) is preferably configured to be capable of detecting the boundaries 42L and 42R and the center line 42C of the road 16 or other stationary or moving objects (e.g., remote vehicles 14). However, the sensor system (sensors 26a-26d) can be any type of system desirable. For example, the front sensors 26a and 26b and rear sensors 26c and 26d in the sensor system (sensors 26a-26d) can include a long-range radar device for detection of a remote vehicle 14 that is located at a distance from the front or the rear of the host vehicle 10. Thus, the radar sensors may be configured to detect objects at a predetermined distance (e.g., distances up to 200 m), and thus may have a narrow field of view angle (e.g., around 15°). Due to the narrow field of view angle, the long-range radar may not detect all objects in the front of in the rear of the host vehicle 10. Thus, if desired, the front sensors 26a and 26b and rear sensors 26c and 26d can include short-range radar devices to assist in monitoring the region in front of or to the rear of the host vehicle 10. However, the sensors in the sensor system (sensors 26a-26d) can be disposed in any position of the host vehicle 10 and may include any type and/or combination of sensors to enable detection of a remote vehicle 14. In addition, the sensor system (sensors 26a-26d) may include cameras (e.g., mounted on the mirrors 46 or any other suitable place), radar sensors, photo sensors or any combination thereof. Although FIG. 2 illustrates four sensor sensors 26a-26d, there can be as few or as many sensors desirable or suitable.

Although the sensor system (sensors 26a-26d) can be electronic detection devices that transmit either electronic electromagnetic waves (e.g., radar), the sensors 26a-26d can be any suitable sensors that, for example, take computer-processed images with a digital camera and analyzes the images or emit lasers, as is known in the art. The sensor system (sensors 26a-26d) may be capable of detecting at least the speed, direction, yaw, acceleration and distance of the host vehicle 10 relative to the boundaries 42L and 42R and the center line 42C of the road 16 or other stationary or moving objects. Further, the sensor system (sensors 26a-26d) may include object-locating sensing devices including range sensors, such as FM-CW (Frequency Modulated Continuous Wave) radars, pulse and FSK (Frequency Shift Keying) radars, sonar and Lidar (Light Detection and Ranging) devices, and ultrasonic devices which rely upon effects such as Doppler-effect measurements to locate forward objects. Object-locating devices may include charged-coupled devices (CCD) or complementary metal oxide semi-conductor (CMOS) video image sensors, and other known camera/video image processors which utilize digital photographic methods to “view” forward objects including one or more remote vehicles 14. The sensor system (sensors 26a-26d) is in communication with the controller 24, and is capable of transmitting information to the controller 24.

The sensor system (sensors 26a-26d) is further capable of detecting remote vehicles 14 both in front of and behind the host vehicle 10. Thus, the sensor system can transmit information relating to the speed and location of a following remote vehicle 14, a leading remote vehicle, a remote vehicle 14 that is traveling in an adjacent lane and traveling in an opposite direction of the host vehicle 10 and any other moving and or stationary remote vehicle 14.

The warning indicator 30 may include warning lights and/or a warning audio output and is in communication with the controller 24. For example, the warning indicator 30 may include a visual display or light indicator that flashes or illuminates the instrument cluster on the instrument panel IP of the host vehicle 10, activates a heads-up display is a visual readout in the display 40, is an audible noise emitted from speaker, or any other suitable visual display or audio or sound indicator or combination thereof that notifies the operator or interior occupant of the host vehicle 10 should transition to a different lane (e.g., the right lane 16R).

As shown in FIG. 2, the mitigation system may include the tactile vibration system 32 which can provide tactile feedback, such as vibrations from a vibration actuator in the steering wheel SW, the driver seat, or any other suitable location within the host vehicle 10. That is, the mitigation operation can include providing haptic feedback to a portion of an interior of the vehicle 10 located proximate to the driver. For example, the mitigation operation may be a feedback force within the steering system that notifies the operator that the steering wheel SW should be turned in a specific direction (e.g., to the right). Such a feedback operation does not necessarily need to alter the trajectory of the vehicle 10 but may be a minor turn of the steering wheel SW simply to notify the driver that a steering wheel operation is necessary. The tactile vibration system 32 can thus provide feedback to the driver based on a predetermined set of criteria. The tactile vibration system 32 is connected to the controller 24, which is programmed to operate the tactile vibration system 32 to warn the driver or control the vehicle 10.

Additionally, the system 12 may also be connected to the steering system of the vehicle 10, such that the controller 24 can control the steering system of the vehicle 10 based on a predetermined set of criteria. The controller 24 can be connected to the steering wheel SW or any other suitable portion of the steering system. That is, the controller 24 can apply an assist force to a portion of the steering system of the vehicle 10 to cause movement of the vehicle 10 towards the right lane 16R. In one embodiment, the controller 24 is capable of performing a lane change operation, such that based upon predetermined criteria, the system 12 performs a mitigation operation which results in the host vehicle 10 changing lanes, for example, the lane to the right of the host vehicle or the right most lane on the road (from lane 16L to lane 16R).

The system 12 may include a positioning system 28, such as a GPS. In one embodiment the vehicle 10 receives a GPS satellite signal. As is understood, the GPS processes the GPS satellite signal to determine positional information (such as location, speed, acceleration, yaw, and direction, just to name a few) of the vehicle 10. The positioning system 28 can provide information to the controller that enables the controller to determine the host vehicle speed, location and travel path. As noted herein, the positioning system 28 is in communication with the controller 24, and is capable of transmitting such positional information regarding the host vehicle 10 to the controller 24. Moreover, the controller can cause host vehicle information (e.g., location, speed, acceleration, yaw, and direction, just to name a few) to remote vehicles 14 via the receiver/transmitter system 36, and receive information (e.g., location, speed, acceleration, yaw, and direction, just to name a few) from remote vehicles 14 via the receiver/transmitter system 36.

The positioning system 28 also can also include or be in communication with the data storage 34 that stores map data. Thus, in determining the position of the host vehicle 10 using any of the herein described methods, devices or systems, the positioning host of the vehicle 10 may be compared to the known data stored in the data storage 34. Thus, the system 12 may accurately determine the location of the host vehicle 10 on an electronic map. For example, the position system can determine the lane in which the host vehicle 10 is located and whether the host vehicle 10 is positioned in the appropriate lane on the road 16. The storage device 34 may also store any additional information including the current or predicted vehicle position and any past vehicle 10 position or any other suitable information.

The receiver/transmitter system 36 is preferably the system that communicates with the two-way wireless communication network discussed above. The receiver/transmitter system 36 is configured to send information to the external server 22, the cloud C or internet. The receiver/transmitter system 36 can send and receive information in any suitable manner, such as data packets. The receiver/transmitter system 36 can send and receive information to and from the two-way wireless communication network, directly to other vehicles (e.g., remote vehicles 14) or in a suitable manner. When communication with other vehicles, the information can be sent directly to the remote vehicle 14, when in range, or through blockchain. Blockchain communication could be encrypted information that is sent from the host vehicle 10 to the remote vehicle 14 through other remote vehicles 14 or portable devices. The electronic controllers of the other vehicles or portable devices would serve as the blocks of the chain between the host vehicle 10 and the remote vehicle 14.

The receiver/transmitter system 36 includes, for example, a receiver and a transmitter configured as individual components or as a transceiver, and any other type of equipment for wireless communication. For example, the receiver/transmitter system 36 is configured to communicate wirelessly over one or more communication paths. Examples of communication paths include a cellular telephone network, a wireless network (Wi-Fi or a WiMAX), a DSRC (Dedicated Short-Range Communications) network, a power line communication network, etc. The receiver/transmitter system 36 is configured to receive information from external sources and to transmit such information to the controller 24. For example, the receiver/transmitter system 36 can communicate with another vehicle, or any other suitable entity via a communication network, direct communication, or in any suitable manner as understood in the art.

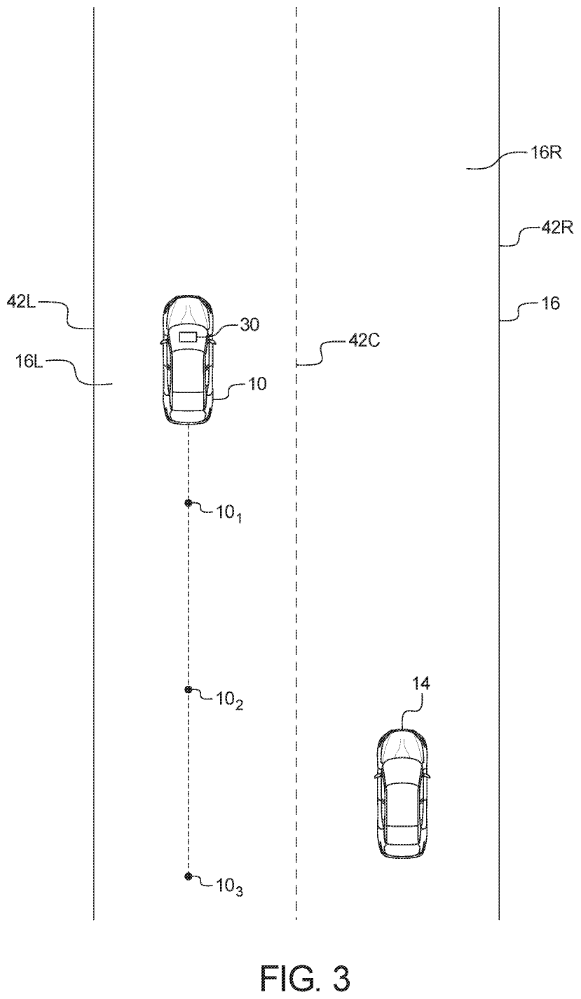

FIGS. 3-8 illustrate embodiments of the present invention in which the host vehicle 10 changes lanes due to the one or more remote vehicles 14 undertaking the host vehicle 10. First, the host vehicle 10 determines the jurisdiction in which it is traveling. In one embodiment, the jurisdiction can be determined by GPS coordinates. That is, the system 12 can use the positioning system 28 to obtain location coordinates and compare to a map stored in the data storage 34. Such information would enable the system 12 to determine the local jurisdiction, and review a stored data table for the jurisdictional requirements. That is, the system would determine the location of the host vehicle 10, determine the host vehicle 10 is within a certain jurisdiction, and review a jurisdictional data base saved in the data storage 34 to determine the jurisdictional requirements for a vehicle being undertaken by a remote vehicle 14. However, a jurisdictional determination can be made in any suitable manner or can be input into the system 12 by an operator.

As shown in FIG. 3, in the illustrated embodiment, the host vehicle 10 is traveling in left lane 16R of a two lane road 16, and the remote vehicle 14 is traveling in the right lane 16R. As stated herein, determination that the host vehicle 10 is traveling in the left lane 16L can be made by the controller in any suitable manner. For example, the positioning system 28 can determine the host vehicle information, including location, speed and travel path. Alternatively, the sensor system 26 can be used in conjunction with the positioning system, 28 or along or in any suitable manner.

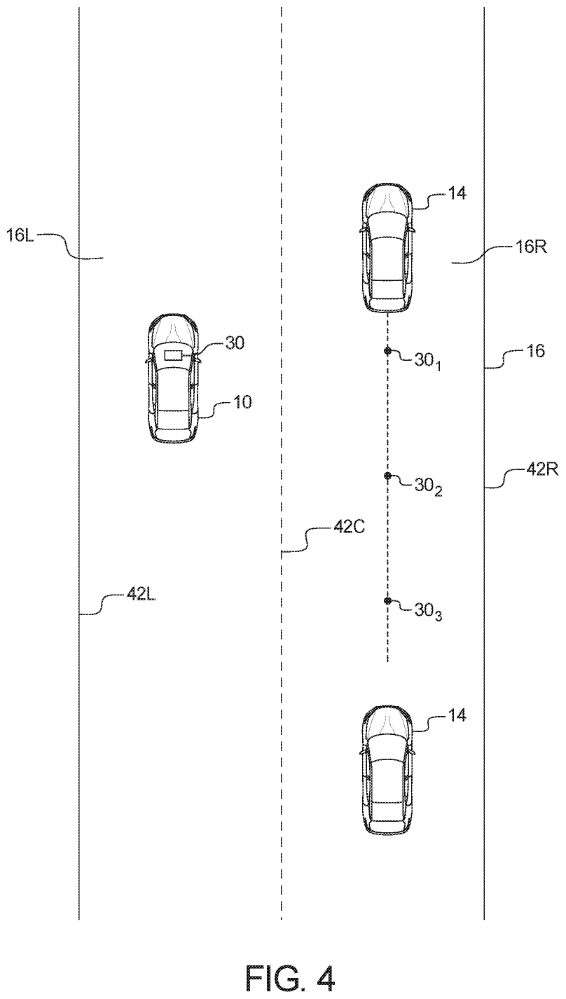

The host vehicle 10 receives or determines remote vehicle information, such as, location, speed, and trajectory (travel path), of the remote vehicle 14 and a lateral distance of the remote vehicle 14 relative to the host vehicle 10, e.g., through vehicle to vehicle communications, the sensor system 26 on the host vehicle 10, or any other suitable or combination of suitable methods of gathering and receiving information. In this embodiment, the system 12 has determined that the remote vehicle 14 is traveling in the right lane 16R and at a specific speed and trajectory. Based on the remote vehicle information and the host vehicle information, the host vehicle 10 determines that the remote vehicle 14 started behind the host vehicle 10 at a predetermined distance, has reduced the distance, and has passed (see e.g., FIG. 4) or will pass the host vehicle 10 on the right side (i.e., undertake the host vehicle). As further illustrated in FIG. 4, a second remote vehicle 14 is traveling along traveling in the right lane 16R. Based on the information received from the first and second remote vehicles 14, e.g., through vehicle to vehicle communications, the sensors 26 on the host vehicle 10, or any other suitable or combination of suitable methods of gathering and receiving information, the host vehicle 10 determines that the second remote vehicle 14 has passed or will pass the host vehicle on the right side (i.e., undertake the host vehicle). In other words, when the controller 24 determines that the remote vehicle 14 is behind the host vehicle 10 and the distance between the host vehicle 10 and the remote vehicle is decreasing, the system 12 can perform a mitigation operation.

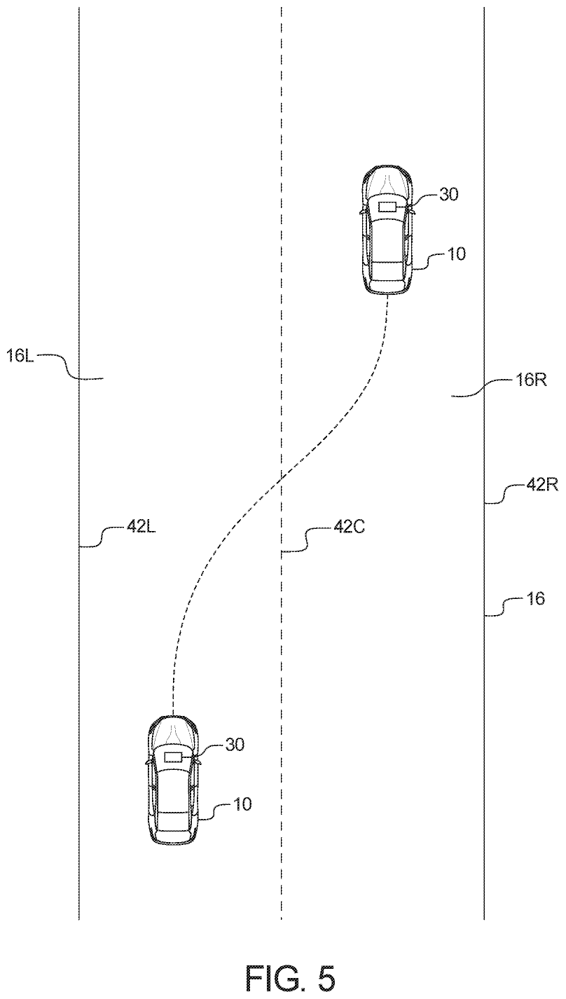

As discussed in more detail below, if the first and second remote vehicles 14 undertake the host vehicle 10 within a predetermined time, the system 12 can determine that a mitigation operation is necessary or warranted. In one embodiment, the mitigation operation is notifying the operator of the host vehicle 10 to move to the right lane 16R or manipulating the steering system to move the host vehicle 10 to the right lane 16R, see for example FIG. 5. In one embodiment, the receiver/transmitter 36 transmits a signal to the remote vehicles 14 indicating that the host vehicle 10 is changing lanes. It is noted that the system 12 can provide cause a mitigation operation to be performed based on one remote vehicle, no remote vehicles or any number of remote vehicles in any time frame desired.

In one embodiment, the controller 24 is configured to determine the travel path of the remote vehicle 14 based on a plurality of position coordinates 301, 302, 303, etc. received by the transmitter/receiver 28 within a predetermined amount of time. That is, the remote vehicle 14 can transmit a position coordinates at predetermine intervals. Based on the position coordinates, the controller 24 can determine the travel path, speed and location of the remote vehicle. Moreover, the system 12, using the positioning system 28 (or any other suitable system) can determine the travel path of the host vehicle 10 based on a plurality of position coordinates 10₁, 10₂, 10₃, etc. within a predetermined amount of time. The controller 24 can then compare the plurality of position coordinates 30₁, 30₂, 30₃, etc. received by the transmitter/receiver 28 with host vehicle position coordinates 10₁, 10₂, 10₃, etc. to determine whether the travel path of the host vehicle 10 and the travel path of the remote vehicle 14 are the same.

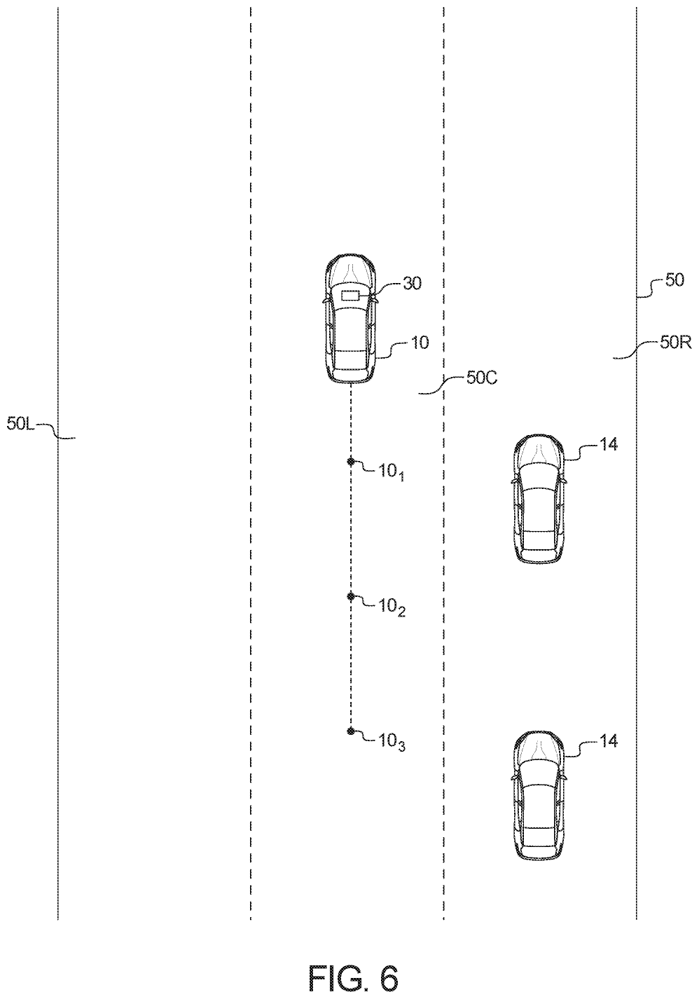

As shown in FIG. 6, in the illustrated embodiment, the host vehicle 10 is traveling in center lane 50C of a road 50. Road 50 is a three lane road with center lane 50C, left lane 50L and right lane 50R. The controller 24 is configured to determine the number of lanes on a road based on the host vehicle location. Remote vehicles 14 are traveling in the right lane 50R. As describe above, first, the host vehicle 10 determines the jurisdiction in which it is traveling. In one embodiment, the jurisdiction can be determined by GPS coordinates. That is, the system 12 can use the positioning system 28 to obtain location coordinates and compare to a map stored in the data storage 34. Such information would enable the system 12 to determine the local jurisdiction, and review a stored data table for the jurisdictional requirements. That is, the system would determine the location of the host vehicle 10, determine the host vehicle 10 is within a certain jurisdiction, and review a jurisdictional data base saved in the data storage 34 to determine the jurisdictional requirements for a vehicle being undertaken by a remote vehicle 14. However, a jurisdictional determination can be made in any suitable manner or can be input into the system 12 by an operator.

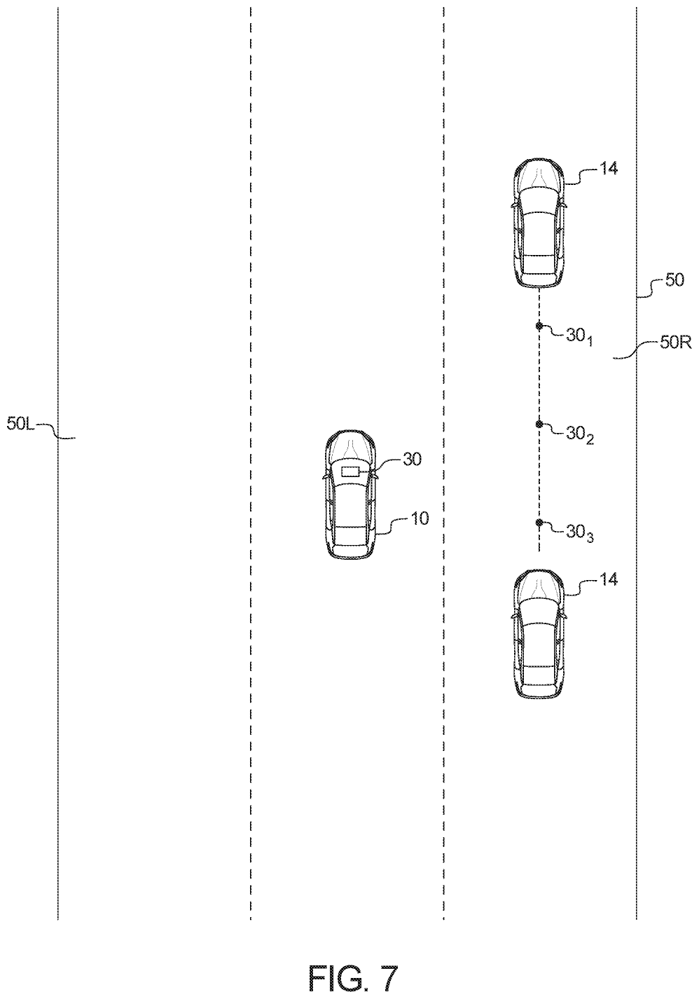

Based on the information (e.g., remote vehicle speed, location and travel path) received from the remote vehicle 14, e.g., through vehicle to vehicle communications, the sensors 26 on the host vehicle 10, or any other suitable or combination of suitable methods of gathering and receiving information, as described herein, the system 12 compares the host vehicle information (speed, location and travel path) with the remote vehicle information to determine that the remote vehicle 14 has passed (see e.g., FIG. 7) or will pass the host vehicle on the right side (i.e., undertake the host vehicle). As further illustrated in FIG. 7, a second remote vehicle 14 is traveling along traveling in the right lane 50R. Based on the information received from the second remote vehicle 14, e.g., through vehicle to vehicle communications, the sensors on the host vehicle, or any other suitable or combination of suitable methods of gathering and receiving information, the host vehicle compares the host vehicle information to the remote vehicle information. Based on the remote vehicle information and the host vehicle information, the host vehicle 10 determines that the remote vehicle 14 started behind the host vehicle 10 at a predetermined distance, has reduced the distance, and the second remote vehicle 14 has passed or will pass the host vehicle 10 on the right side (i.e., undertake the host vehicle). In other words, when the controller 24 determines that the remote vehicle 14 is behind the host vehicle 10 and the distance between the host vehicle 10 and the remote vehicle is decreasing, the system 12 can perform a mitigation operation.

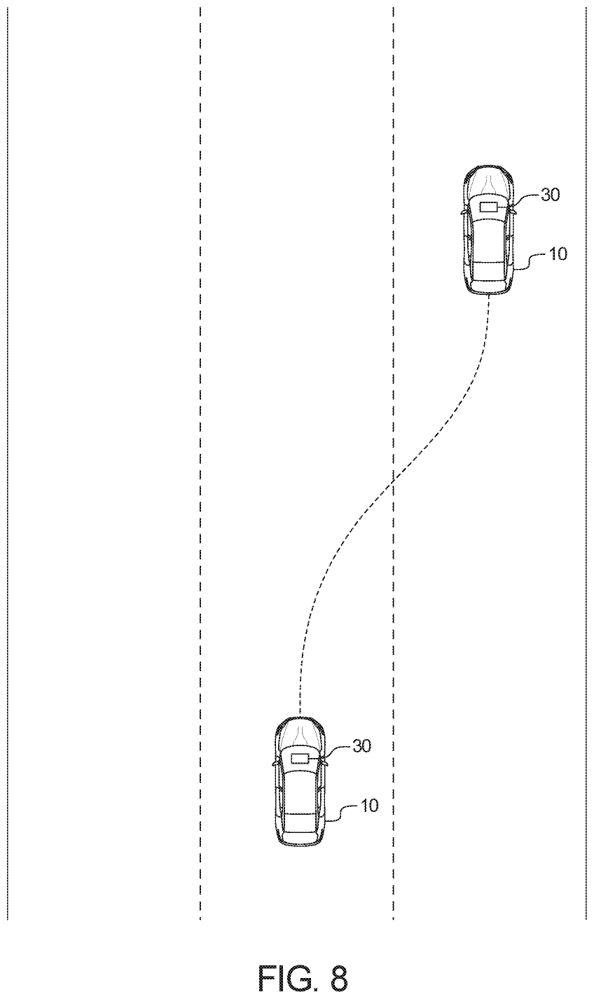

As discussed in more detail below, if the first and second remote vehicles 14 undertake the host vehicle within a predetermined time, the system 12 can determine that a mitigation operation is necessary or warranted. In one embodiment, the mitigation operation is notifying the operator of the host vehicle 10 to move to the right most lane or manipulating the steering system to move the host vehicle 10 to the right lane 16R, see for example FIG. 8. However, it is noted that the system 12 can provide cause a mitigation operation to be performed based on one remote vehicle, no remote vehicles or any number of remote vehicles in any time frame desired.

In one embodiment, the controller 24 has programmed parameters to determine whether a mitigation operation is warranted. For example, the controller can include a timer that determines whether a predetermined time has elapsed between multiple remote vehicles 14 undertaking the host vehicle 10. In other words, in some embodiments, it may be acceptable for a single remote vehicle 14 to undertake a host vehicle 10, or a single remote vehicle to undertake the host vehicle within a predetermined time frame or range (e.g., 3 minutes). Thus, if a predetermined number of remote vehicles (e.g., 2 remote vehicles) undertake the host vehicle 10 within a predetermined number of seconds or minutes, the host vehicle 10 will perform a mitigation operation.

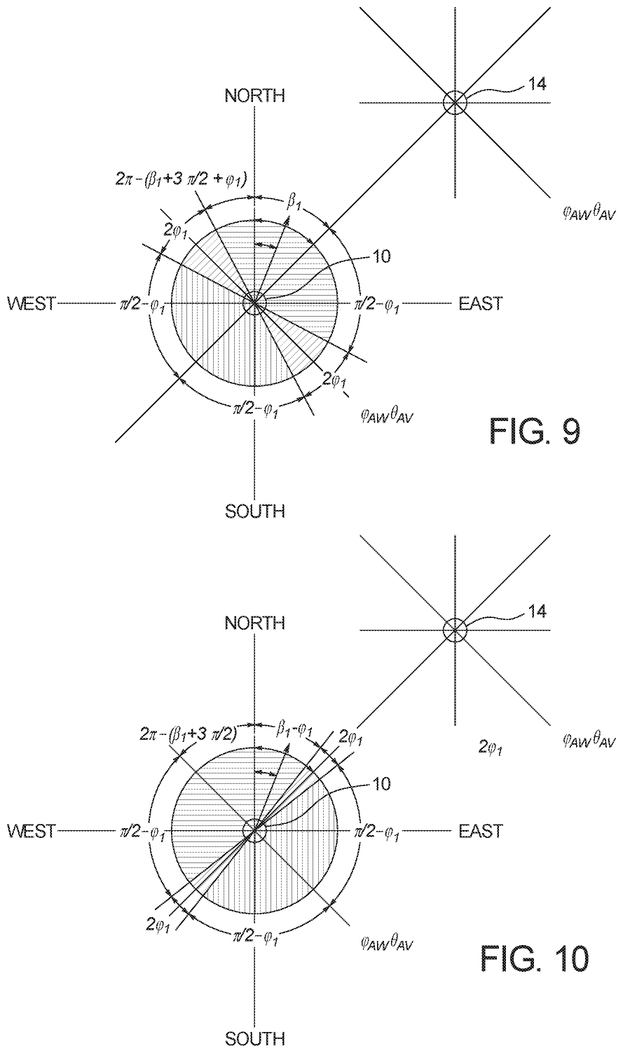

FIGS. 9-16 illustrate the steps for determining the location, heading and speed of a remote vehicle 14. A series of mathematical expressions can be defined that provide specific information regarding the longitudinal, lateral, elevation and heading of the remote vehicles 14 relative to the host vehicle 10. In other words, the system 12 determines the position and direction of remote vehicles 14 relative to the host vehicle 10, based on the known position, direction and speed, for example, of the host vehicle 10 and the known position, direction and/or speed, for example, of each of the remote vehicles 14, the system 12 can determine whether the remote vehicle is in adjacent lane to the host vehicle is behind the host vehicle or ahead of the host vehicle. The equations are defined as follows.

### Remote Vehicle Position Relative to Host Vehicle (Longitudinal and Lateral Position)

Q1: remote vehicle 14 is to the Northeast of the host vehicle 10

$${Q}_{1} = \frac{1}{4} [ \frac{{φ}_{RV} - {φ}_{HV} - σ}{\vert {φ}_{RV} - {φ}_{HV} \vert + σ} + 1 ] \times [ \frac{{θ}_{RV} - {θ}_{HV} + σ}{\vert {θ}_{RV} - {θ}_{HV} \vert + σ} + 1 ]$$

If the remote vehicle 14 is northeast of the host vehicle 10, as shown in FIGS. 7 and 8, both latitude and longitude for the remote vehicle 14 is greater than the latitude and longitude for the host vehicle 10. Under these conditions, the expression for Q₁ above will equal 1 otherwise it will equal 0.

### Longitudinal Position (XW)

The remote vehicle 14 is ahead (XW=00) of the host vehicle 10 if:

0≤δ_{HV}<A₁ or A₂≤δ_{HV}<2π

Where:

A₁=β₁+π/2−φ₁

A₄=β₁+3π/2+φ₁

φ₁ is a threshold value that defines the angular range in which the remote vehicle 14 is defined to be adjacent to the host vehicle 10

$${β}_{1} = π [ \frac{{θ}_{HV} - {θ}_{RV} - σ}{\vert {θ}_{HV} - {θ}_{RV} \vert + σ} + 1 ] - {cos}^{- 1} ( \frac{( {φ}_{RV} - {φ}_{HV} )}{\sqrt{{( {θ}_{RV} - {θ}_{HV} )}^{2} {cos}^{2} {φ}_{HV} + {( {φ}_{RV} - {φ}_{HV} )}^{2}}} ) [ \frac{{θ}_{HV} - {θ}_{RV} + σ}{\vert {θ}_{HV} - {θ}_{RV} \vert + σ} ]$$

This region is identified as the horizontal cross hatching area in FIG. 7. These conditions can be defined in one mathematical expression as:

$${P}_{{Q}_{1}} = \frac{1}{4} [ \frac{{δ}_{HV} - 0 + σ}{\vert {δ}_{HV} - 0 \vert + σ} + 1 ] \times [ \frac{{A}_{1} - {δ}_{HV} - σ}{\vert {A}_{1} - {δ}_{HV} \vert + σ} + 1 ] + \frac{1}{4} [ \frac{{δ}_{HV} - {A}_{4} + σ}{\vert {δ}_{HV} - {A}_{4} \vert + σ} + 1 ] \times [ \frac{2 π - {δ}_{HV} - σ}{\vert 2 π - {δ}_{HV} \vert + σ} + 1 ]$$

The remote vehicle 14 is adjacent (XW=01) to the host vehicle 10 if:

A₁≤δ_{HV}<A₂ or A₃≤δ_{HV}<A₄

Where:

A₁=β₁+π/2−φ₁

A₂=β₁+π/2+φ₁

A₃−β₁+3π/2−φ₁

A₄=β₁+3π/2+φ₁

These two specific angular ranges are identified as the interface between the vertical cross hatching area and horizontal cross hatching area in FIG. 9. These conditions can be defined in one mathematical expression as:

$${A}_{{Q}_{1}} = \frac{1}{4} [ \frac{{δ}_{HV} - {A}_{1} + σ}{\vert {δ}_{HV} - {A}_{1} \vert + σ} + 1 ] \times [ \frac{{A}_{2} - {δ}_{HV} - σ}{\vert {A}_{2} - {δ}_{HV} \vert + σ} + 1 ] + \frac{1}{4} [ \frac{{δ}_{HV} - {A}_{3} + σ}{\vert {δ}_{HV} - {A}_{3} \vert + σ} + 1 ] \times [ \frac{{A}_{4} - {δ}_{HV} - σ}{\vert {A}_{4} - {δ}_{HV} \vert + σ} + 1 ]$$

The remote vehicle 14 is behind (XW=10) the host vehicle 10 if:

A₂≤δ_{HV}<A₃

Where:

A₂=β₁+π/2+φ₁

A₃=β₁+3π/2−φ₁

This region is identified as the vertical cross hatching area in FIG. 9. These conditions can be defined in one mathematical expression as:

$${B}_{{Q}_{1}} = \frac{1}{4} [ \frac{{δ}_{HV} - {A}_{2} + σ}{\vert {δ}_{HV} - {A}_{2} \vert + σ} + 1 ] \times [ \frac{{A}_{3} - {δ}_{HV} - σ}{\vert {A}_{3} - {δ}_{HV} \vert + σ} + 1 ]$$

### Lateral Position (VU)

The remote vehicle 14 is in lane (VU=00) with the host vehicle 10 if:

A₅≤δ_{HV}<A₆ or A₇≤δ_{HV}<A₈

Where:

A₅=β₁−φ₂

A₆=β₁+φ₂

A₇=β₁+π−φ₂

A₈=β₁+π+φ₂

φ₂ is a threshold value that defines the angular range in which the remote vehicle 14 is defined to be in the same lane with the host vehicle 10.

These two specific angular ranges are identified as the interface between the horizontal cross-sectional area and vertical cross-sectional area in FIG. 10. These conditions can be defined in one mathematical expression as:

$${I}_{{Q}_{1}} = \frac{1}{4} [ \frac{{δ}_{HV} - {A}_{5} + σ}{\vert {δ}_{HV} - {A}_{5} \vert + σ} + 1 ] \times [ \frac{{A}_{6} - {δ}_{HV} - σ}{\vert {A}_{6} - {δ}_{HV} \vert + σ} + 1 ] + \frac{1}{4} [ \frac{{δ}_{HV} - {A}_{7} + σ}{\vert {δ}_{HV} - {A}_{8} \vert + σ} + 1 ] \times [ \frac{{A}_{8} - {δ}_{HV} - σ}{\vert {A}_{8} - {δ}_{HV} \vert + σ} + 1 ]$$

The remote vehicle 14 is to the left (VU=01) of the host vehicle 10 if:

A₆≤δ_{HV}<A₇

Where:

A₆=β₁+φ₂

A₇=β₁+π−φ₂

This region is identified as the vertical cross-sectional area in FIG. 10. These conditions can be defined in one mathematical expression as:

$${L}_{{Q}_{1}} = \frac{1}{4} [ \frac{{δ}_{HV} - {A}_{6} + σ}{\vert {δ}_{HV} - {A}_{6} \vert + σ} + 1 ] \times [ \frac{{A}_{7} - {δ}_{HV} - σ}{\vert {A}_{7} - {δ}_{HV} \vert + σ} + 1 ]$$

The remote vehicle 14 is to the right (VU=10) of the host vehicle 10 if:

0≤δ_{HV}<A₅ or A₈≤δ_{HV}<2π

Where:

A₅=β₁−φ₂

A₈=β₁+π−φ₂

This region is identified as the horizontal cross-sectional area in FIG. 10. These conditions can be defined in one mathematical expression as:

$${R}_{{Q}_{1}} = \frac{1}{4} [ \frac{{δ}_{HV} - 0 + σ}{\vert {δ}_{HV} - 0 \vert + σ} + 1 ] \times [ \frac{{A}_{5} - {δ}_{HV} - σ}{\vert {A}_{5} - {δ}_{HV} \vert + σ} + 1 ] + \frac{1}{4} [ \frac{{δ}_{HV} - {A}_{8} + σ}{\vert {δ}_{HV} - {A}_{8} \vert + σ} + 1 ] \times [ \frac{2 π - {δ}_{HV} - σ}{\vert 2 π - {δ}_{HV} \vert + σ} + 1 ]$$

The expressions are then consolidated in Table 1 for the case when the remote vehicle 14 is to the northeast of the host vehicle 10.

TABLE 1

| | | Lateral Position | | | |
|---|---|---|---|---|---|
| | | Remote vehicle | Remote vehicle | Remote vehicle | |
| Q₁ | | in lane (I_{Q}_{₁}) | Left (L_{Q}_{₁}) | Right (R_{Q}_{₁}) | Unused |
| Longitudinal | Remote vehicle | Q₁ × P_{Q}_{₁} × I_{Q}_{₁} | Q₁ × P_{Q}_{₁} × L_{Q}_{₁} | Q₁ × P_{Q}_{₁} × R_{Q}_{₁} | 0 |
| Position | Ahead (P_{Q}_{₁}) | | | | |
| | Remote vehicle | Q₁ × A_{Q}_{₁} × I_{Q}_{₁} | Q₁ × A_{Q}_{₁} × L_{Q}_{₁} | Q₁ × A_{Q}_{₁} × R_{Q}_{₁} | 0 |
| | Adjacent (A_{Q}_{₁}) | | | | |
| | Remote vehicle | Q₁ × B_{Q}_{₁} × I_{Q}_{₁} | Q₁ × B_{Q}_{₁} × L_{Q}_{₁} | Q₁ × B_{Q}_{₁} × R_{Q}_{₁} | 0 |
| | Behind (B_{Q}_{₁}) | | | | |
| | Unused | 0 | 0 | 0 | 0 |

### Q2: Remote Vehicle is to the Northwest of the Host Vehicle

$${Q}_{2} = \frac{1}{4} [ \frac{{φ}_{RV} - {φ}_{HV} + σ}{\vert {φ}_{RV} - {φ}_{HV} \vert + σ} + 1 ] \times [ \frac{{θ}_{HV} - {θ}_{RV} - σ}{\vert {θ}_{HV} - {θ}_{RV} \vert + σ} + 1 ]$$

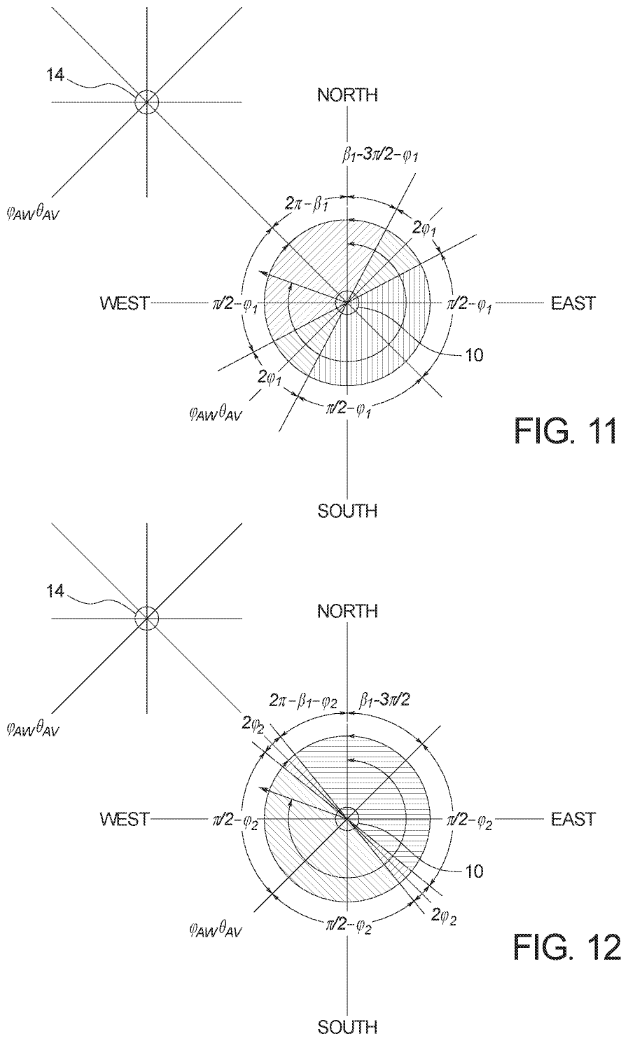

If the remote vehicle 14 is northwest of the Host vehicle 10 as shown in FIGS. 11 and 12, the latitude for the remote vehicle 14 is greater than the latitude of the host vehicle 10 but the longitude for the remote vehicle 14 is less than the longitude for the host vehicle 10. Under these conditions, the expression for Q₂ above will equal 1 otherwise it will equal 0.

### Longitudinal Position (XW)

The remote vehicle 14 is ahead (XW=00) of the host vehicle 10 if:

0≤δ_{HV}<A₉ or A₁₂≤δ_{HV}<2π

Where:

A₉=β₁−3π/2−φ₁

A₁₂=β₁−π/2+φ₁

φ₁ is a threshold value that defines the angular range in which the remote vehicle 14 is defined to be adjacent to the host vehicle 10.

$${β}_{1} = π [ \frac{{θ}_{HV} - {θ}_{RV} - σ}{\vert {θ}_{HV} - {θ}_{RV} \vert + σ} + 1 ] - {cos}^{- 1} ( \frac{( {φ}_{RV} - {φ}_{HV} )}{\sqrt{{( {θ}_{RV} - {θ}_{HV} )}^{2} {cos}^{2} {φ}_{HV} + {( {φ}_{RV} - {φ}_{HV} )}^{2}}} ) [ \frac{{θ}_{HV} - {θ}_{RV} - σ}{\vert {θ}_{HV} - {θ}_{RV} \vert + σ} ]$$

This region is identified as the diagonal (from upper right to lower left) sectional area in FIG. 11. These conditions can be defined in one mathematical expression as:

$${P}_{{Q}_{2}} = \frac{1}{4} [ \frac{{δ}_{HV} - 0 + σ}{\vert {δ}_{HV} - 0 \vert + σ} + 1 ] \times [ \frac{{A}_{9} - {δ}_{HV} - σ}{\vert {A}_{9} - {δ}_{HV} \vert + σ} + 1 ] + \frac{1}{4} [ \frac{{δ}_{HV} - {A}_{12} + σ}{\vert {δ}_{HV} - {A}_{12} \vert + σ} + 1 ] \times [ \frac{2 π - {δ}_{HV} - σ}{\vert 2 π - {δ}_{HV} \vert + σ} + 1 ]$$

The remote vehicle 14 is adjacent (XW=01) to the host vehicle 10 if:

A₉≤δ_{HV}<A₁₀ or A₁₁≤δ_{HV}<A₁₂

Where:

A₉=β₁−3π/2−φ₁

A₁₀=β₁−3π/2+φ₁

A₁₁=β₁−π/2−φ₁

A₁₂=β₁−π/2+φ₁

These two specific angular ranges are identified as the interface between the vertical cross-sectional area and the diagonal (from upper right to lower left) cross sectional area in FIG. 11. These conditions can be defined in one mathematical expression as:

$${A}_{{Q}_{2}} = \frac{1}{4} [ \frac{{δ}_{HV} - {A}_{9} + σ}{\vert {δ}_{HV} - {A}_{9} \vert + σ} + 1 ] \times [ \frac{{A}_{10} - {δ}_{HV} - σ}{\vert {A}_{10} - {δ}_{HV} \vert + σ} + 1 ] + \frac{1}{4} [ \frac{{δ}_{HV} - {A}_{11} + σ}{\vert {δ}_{HV} - {A}_{11} \vert + σ} + 1 ] \times [ \frac{{A}_{12} - {δ}_{HV} - σ}{\vert {A}_{12} - {δ}_{HV} \vert + σ} + 1 ]$$

The remote vehicle 14 is behind (XW=10) the host vehicle 10 if:

A₁₀≤δ_{HV}<A₁₁

Where:

A₁₀=β₁−3π/2+φ₁

A₁₁=β₁−π/2−φ₁

This region is identified as the vertical cross-sectional area in FIG. 11. These conditions can be defined in one mathematical expression as:

$${B}_{{Q}_{2}} = \frac{1}{4} [ \frac{{δ}_{HV} - {A}_{10} + σ}{\vert {δ}_{HV} - {A}_{10} \vert + σ} + 1 ] \times [ \frac{{A}_{11} - {δ}_{HV} - σ}{\vert {A}_{11} - {δ}_{HV} \vert + σ} + 1 ]$$

### Lateral Position (VU)

The remote vehicle 14 is in lane (VU=00) with the host vehicle 10 if:

A₁₃≤δ_{HV}<A₁₄ or A₁₅≤δ_{HV}<A₁₆

Where:

A₁₃=β₁−π−φ₂

A₁₄=β₁−π+φ₂

A₁₅=β₁−φ₂

A₁₆=β₁+φ₂

φ₂ is a threshold value that defines the angular range in which the remote vehicle 14 is defined to be in the same lane with the host vehicle 10.

These two specific angular ranges are identified as the interface between the horizontal cross sectional area and the diagonal (from upper left to lower right) sectional area in FIG. 12. These conditions can be defined in one mathematical expression as:

$${I}_{{Q}_{2}} = \frac{1}{4} [ \frac{{δ}_{HV} - {A}_{13} + σ}{\vert {δ}_{HV} - {A}_{13} \vert + σ} + 1 ] \times [ \frac{{A}_{14} - {δ}_{HV} - σ}{\vert {A}_{14} - {δ}_{HV} \vert + σ} + 1 ] + \frac{1}{4} [ \frac{{δ}_{HV} - {A}_{15} + σ}{\vert {δ}_{HV} - {A}_{15} \vert + σ} + 1 ] \times [ \frac{{A}_{16} - {δ}_{HV} - σ}{\vert {A}_{16} - {δ}_{HV} \vert + σ} + 1 ]$$

The remote vehicle 14 is to the left (VU=01) of the host vehicle 10 if:

0≤δ_{HV}<A₁₃ or A₁₆≤δ_{HV}<2π

Where:

A₁₃=β₁−π−φ₂

A₁₆=β₁+φ₂

This region is identified as the blue shaded area in the illustration on the right side of FIG. 12. These conditions can be defined in one mathematical expression as:

$${L}_{{Q}_{2}} = \frac{1}{4} [ \frac{{δ}_{HV} - 0 + σ}{\vert {δ}_{HV} - 0 \vert + σ} + 1 ] \times [ \frac{{A}_{13} - {δ}_{HV} - σ}{\vert {A}_{13} - {δ}_{HV} \vert + σ} + 1 ] + \frac{1}{4} [ \frac{{δ}_{HV} - {A}_{16} + σ}{\vert {δ}_{HV} - {A}_{16} \vert + σ} + 1 ] \times [ \frac{2 π - {δ}_{HV} - σ}{\vert 2 π - {δ}_{HV} \vert + σ} + 1 ]$$

The remote vehicle 14 is to the right (VU=10) of the host vehicle 10 if:

A₁₄≤δ_{HV}<A₁₅

Where:

A₁₄=)⁸₁+T₂

A₁₅=β₁−β₂

This region is identified as the diagonal (from upper left to lower right) sectional area in FIG. 12. These conditions can be defined in one mathematical expression as:

$${R}_{{Q}_{2}} = \frac{1}{4} [ \frac{{δ}_{HV} - {A}_{14} + σ}{\vert {δ}_{HV} - {A}_{14} \vert + σ} + 1 ] \times [ \frac{{A}_{15} - {δ}_{HV} - σ}{\vert {A}_{15} - {δ}_{HV} \vert + σ} + 1 ]$$

The expressions are then consolidated in Table 2 for the case when the remote vehicle 14 is to the northwest of the host vehicle 10.

TABLE 2

| | | Lateral Position | | | |
|---|---|---|---|---|---|
| | | Remote vehicle | Remote vehicle | Remote vehicle | |
| Q₂ | | in lane (I_{Q}_{₂}) | Left (L_{Q}_{₂}) | Right (R_{Q}_{₂}) | Unused |
| Longitudinal | Remote vehicle | Q₂ × P_{Q}_{₂} × I_{Q}_{₂} | Q₂ × P_{Q}_{₂} × L_{Q}_{₂} | Q₂ × P_{Q}_{₂} × R_{Q}_{₂} | 0 |
| Position | Ahead (P_{Q}_{₂}) | | | | |
| | Remote vehicle | Q₂ × A_{Q}_{₂} × I_{Q}_{₂} | Q₂ × A_{Q}_{₂} × L_{Q}_{₂} | Q₂ × A_{Q}_{₂} × R_{Q}_{₂} | 0 |
| | Adjacent (A_{Q}_{₂}) | | | | |
| | Remote vehicle | Q₂ × B_{Q}_{₂} × I_{Q}_{₂} | Q₂ × B_{Q}_{₂} × L_{Q}_{₂} | Q₂ × B_{Q}_{₂} × R_{Q}_{₂} | 0 |
| | Behind (B_{Q}_{₂}) | | | | |
| | Unused | 0 | 0 | 0 | 0 |

### Q3: Remote Vehicle is to the Southwest of the Host Vehicle

$${Q}_{3} = \frac{1}{4} [ \frac{{φ}_{HV} - {φ}_{RV} - σ}{\vert {φ}_{HV} - {φ}_{RV} \vert + σ} + 1 ] \times [ \frac{{θ}_{HV} - {θ}_{RV} + σ}{\vert {θ}_{HV} - {θ}_{RV} \vert + σ} + 1 ]$$

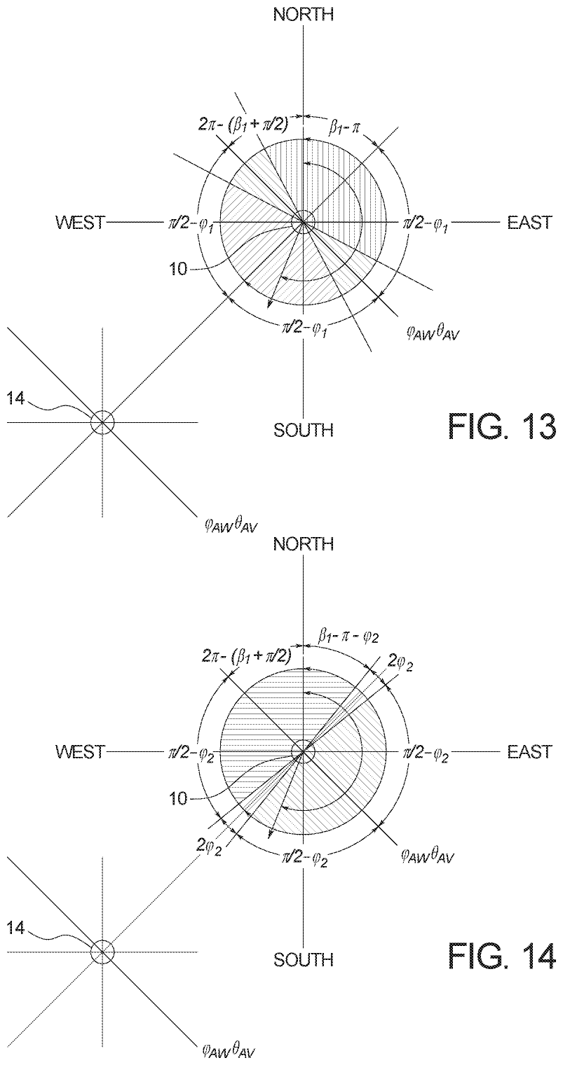

If the remote vehicle 14 is southwest of the host vehicle 10 as shown in FIGS. 13 and 14, both latitude and longitude for the remote vehicle 14 is less than the latitude and longitude for the host vehicle 10. Under these conditions, the expression for Q₃ above will equal 1 otherwise it will equal 0.

### Longitudinal Position (XW)

The remote vehicle 14 is ahead (XW=00) of the host vehicle 10 if:

A₁₂≤δ_{HV}<A₁

Where:

A₁₂=β₁−π/2+φ₁

A₁=β₁+π/2−φ₁

φ₁ is a threshold value that defines the angular range in which the remote vehicle 14 is defined to be adjacent to the host vehicle 10

$${β}_{1} = π [ \frac{{θ}_{HV} - {θ}_{RV} - σ}{\vert {θ}_{HV} - {θ}_{RV} \vert + σ} + 1 ] - {cos}^{- 1} ( \frac{( {φ}_{RV} - {φ}_{HV} )}{\sqrt{{( {θ}_{RV} - {θ}_{HV} )}^{2} {cos}^{2} {φ}_{HV} + {( {φ}_{RV} - {φ}_{HV} )}^{2}}} ) [ \frac{{θ}_{HV} - {θ}_{RV} - σ}{\vert {θ}_{HV} - {θ}_{RV} \vert + σ} ]$$

This region is identified as the diagonal (upper right to lower left) cross sectional area in FIG. 13. These conditions can be defined in one mathematical expression as:

$${P}_{{Q}_{3}} = \frac{1}{4} [ \frac{{δ}_{HV} - {A}_{12} + σ}{\vert {δ}_{HV} - {A}_{12} \vert + σ} + 1 ] \times [ \frac{{A}_{1} - {δ}_{HV} - σ}{\vert {A}_{1} - {δ}_{HV} \vert + σ} + 1 ]$$

The remote vehicle 14 is adjacent (XW=01) to the host vehicle 10 if:

A₁≤δ_{HV}<A₂ or A₁₁≤δ_{HV}<A₁₂

Where:

A₁=β₁+π/2−φ₁

A₂=β₁+π/2+φ₁

A₁₁=β₁−π/2−φ₁

A₁₂=β₁−π/2+φ₁

These two specific angular ranges are identified as the interface between the vertical cross-sectional area and the diagonal (upper right to lower left) cross sectional area in FIG. 13. These conditions can be defined in one mathematical expression as:

$${A}_{{Q}_{3}} = \frac{1}{4} [ \frac{{δ}_{HV} - {A}_{1} + σ}{\vert {δ}_{HV} - {A}_{1} \vert + σ} + 1 ] \times [ \frac{{A}_{2} - {δ}_{HV} - σ}{\vert {A}_{2} - {δ}_{HV} \vert + σ} + 1 ] + \frac{1}{4} [ \frac{{δ}_{HV} - {A}_{11} + σ}{\vert {δ}_{HV} - {A}_{11} \vert + σ} + 1 ] \times [ \frac{{A}_{12} - {δ}_{HV} - σ}{\vert {A}_{12} - {δ}_{HV} \vert + σ} + 1 ]$$

The remote vehicle 14 is behind (XW=10) the host vehicle 10 if:

0≤δ_{HV}<A₁₁ or A₂≤δ_{HV}<2π

Where:

A₂=β₁+π/2+φ₁

A₁₁=β₁−π/2−φ₁

This region is identified as the vertical cross-sectional area in FIG. 13. These conditions can be defined in one mathematical expression as:

$${B}_{{Q}_{3}} = \frac{1}{4} [ \frac{{δ}_{HV} - 0 + σ}{\vert {δ}_{HV} - 0 \vert + σ} + 1 ] \times [ \frac{{A}_{11} - {δ}_{HV} - σ}{\vert {A}_{11} - {δ}_{HV} \vert + σ} + 1 ] + \frac{1}{4} [ \frac{{δ}_{HV} - {A}_{2} + σ}{\vert {δ}_{HV} - {A}_{2} \vert + σ} + 1 ] \times [ \frac{2 π - {δ}_{HV} - σ}{\vert 2 π - {δ}_{HV} \vert + σ} + 1 ]$$

### Lateral Position (VU)

The remote vehicle 14 is in lane (VU=00) with the host vehicle 10 if:

A₁₃≤δ_{HV}<A₁₄ or A₁₅≤δ_{HV}<A₁₆

Where:

A₁₃=β₁−π−φ₂

A₁₄=β₁−π+φ₂

A₁₅=β₁−φ₂

A₁₆=β₁+φ₂

φ₂ is a threshold value that defines the angular range in which the remote vehicle 14 is defined to be in the same lane with the host vehicle 10

These two specific angular ranges are identified as the interface between the diagonal (upper left to lower right) cross sectional area and the horizontal area in FIG. 14. These conditions can be defined in one mathematical expression as:

$${I}_{{Q}_{3}} = \frac{1}{4} [ \frac{{δ}_{H V} - {A}_{13} + σ}{\vert {δ}_{H V} - {A}_{13} \vert + σ} + 1 ] \times [ \frac{{A}_{14} - {δ}_{H V} - σ}{\vert {A}_{14} - {δ}_{H V} \vert + σ} + 1 ] + \frac{1}{4} [ \frac{{δ}_{H V} - {A}_{15} + σ}{\vert {δ}_{H V} - {A}_{15} \vert + σ} + 1 ] \times [ \frac{{A}_{16} - {δ}_{H V} - σ}{\vert {A}_{16} - {δ}_{H V} \vert + σ} + 1 ]$$

The remote vehicle 14 is to the left (VU=01) of the host vehicle 10 if:

0≤δ_{HV}<A₁₃ or A₁₆≤δ_{HV}<2π

A₁₃=β₁−π−φ₂

A₁₆=β₁+φ₂

This region is identified as the horizontal area in FIG. 14. These conditions can be defined in one mathematical expression as:

$${L}_{{Q}_{4}} = \frac{1}{4} [ \frac{{δ}_{H V} - 0 + σ}{\vert {δ}_{H V} - 0 \vert + σ} + 1 ] \times [ \frac{{A}_{13} - {δ}_{H V} - σ}{\vert {A}_{13} - {δ}_{H V} \vert + σ} + 1 ] + \frac{1}{4} [ \frac{{δ}_{H V} - {A}_{16} + σ}{\vert {δ}_{H V} - {A}_{16} \vert + σ} + 1 ] \times [ \frac{2 π - {δ}_{H V} - σ}{\vert 2 π - {δ}_{H V} \vert + σ} + 1 ]$$

The remote vehicle 14 is to the right (VU=10) of the host vehicle 10 if:

A₁₄≤δ_{HV}<A₁₅

Where:

A₁₄=β₁−π+φ₂

A₁₅=β₁−φ₂

This region is identified as the diagonal (upper left to lower right) cross sectional area in FIG. 14. These conditions can be defined in one mathematical expression as:

$${R}_{{Q}_{3}} = \frac{1}{4} [ \frac{{δ}_{H V} - {A}_{14} + σ}{\vert {δ}_{H V} - {A}_{14} \vert + σ} + 1 ] \times [ \frac{{A}_{15} - {δ}_{H V} - σ}{\vert {A}_{15} - {δ}_{H V} \vert + σ} + 1 ]$$

The expressions are then consolidated in Table 3 for the case when the remote vehicle 14 is to the southwest of the host vehicle 10.

TABLE 3

| | | Lateral Position | | | |
|---|---|---|---|---|---|
| | | Remote vehicle | Remote vehicle | Remote vehicle | |
| Q₃ | | in lane (I_{Q}_{₃}) | Left (L_{Q}_{₃}) | Right (R_{Q}_{₃}) | Unused |
| Longitudinal | Remote vehicle | Q₃ × P_{Q}_{₃} × I_{Q}_{₃} | Q₃ × P_{Q}_{₃} × L_{Q}_{₃} | Q₃ × P_{Q}_{₃} × R_{Q}_{₃} | 0 |
| Position | Ahead (P_{Q}_{₃}) | | | | |
| | Remote vehicle | Q₃ × A_{Q}_{₃} × I_{Q}_{₃} | Q₃ × A_{Q}_{₃} × L_{Q}_{₃} | Q₃ × A_{Q}_{₃} × R_{Q}_{₃} | 0 |
| | Adjacent (A_{Q}_{₃}) | | | | |
| | Remote vehicle | Q₃ × B_{Q}_{₃} × I_{Q}_{₃} | Q₃ × B_{Q}_{₃} × L_{Q}_{₃} | Q₃ × B_{Q}_{₃} × R_{Q}_{₃} | 0 |
| | Behind (B_{Q}_{₃}) | | | | |
| | Unused | 0 | 0 | 0 | 0 |

### Q4: Remote Vehicle is to the Southeast of the Host Vehicle

$${Q}_{4} = \frac{1}{4} [ \frac{{φ}_{HV} - {φ}_{R V} + σ}{\vert {φ}_{HV} - {φ}_{R V} \vert + σ} + 1 ] \times [ \frac{{θ}_{R V} - {θ}_{HV} - σ}{\vert {θ}_{R V} - {θ}_{HV} \vert + σ} + 1 ]$$

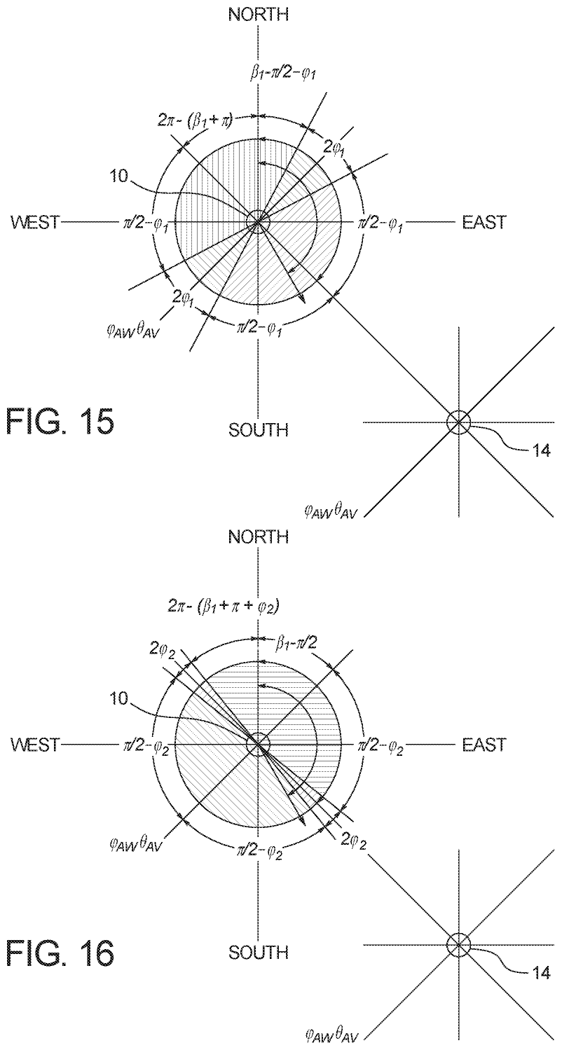

If the remote vehicle 14 is southeast of the Host vehicle 10 as shown in FIGS. 15 and 16, the latitude for the remote vehicle 14 is less than the latitude of the host vehicle 10 but the longitude for the remote vehicle 14 is greater than the longitude for the host vehicle 10. Under these conditions, the expression for Q₄ above will equal 1 otherwise it will equal 0.

### Longitudinal Position (XW)

The remote vehicle 14 is ahead (XW=00) of the host vehicle 10 if:

A₁₂≤δ_{HV}<A₁

Where:

A₁+β₁+π/2−φ₁

A₁₂+β₁−π/2+φ₁

φ₁ is a threshold value that defines the angular range in which the remote vehicle 14 is defined to be adjacent to the host vehicle 10

$${β}_{1} = π [ \frac{{θ}_{HV} - {θ}_{R V} - σ}{\vert {θ}_{HV} - {θ}_{R V} \vert + σ} + 1 ] - {cos}^{- 1} ( \frac{( {φ}_{R V} - {φ}_{HV} )}{\sqrt{{( {θ}_{R V} - {θ}_{H V} )}^{2} {cos}^{2} {φ}_{HV} + {( {φ}_{R V} - {φ}_{HV} )}^{2}}} ) [ \frac{{θ}_{HV} - {θ}_{R V} - σ}{\vert {θ}_{HV} - {θ}_{R V} \vert + σ} ]$$

This region is identified as the diagonal (from upper right to lower left) cross sectional area in FIG. 15. These conditions can be defined in one mathematical expression as:

$${P}_{{Q}_{4}} = \frac{1}{4} [ \frac{{δ}_{H V} - {A}_{12} + σ}{\vert {δ}_{H V} - {A}_{12} \vert + σ} + 1 ] \times [ \frac{{A}_{1} - {δ}_{H V} - σ}{\vert {A}_{1} - {δ}_{H V} \vert + σ} + 1 ]$$

The remote vehicle 14 is adjacent (XW=01) to the host vehicle 10 if:

A₁≤δ_{HV}A₂ or A₁₁≤δ_{HV}<A₁₂

Where:

A₁=β₁+π/2−φ₁

A₂=β₁+π/2+φ₁

A₁₁=β₁−π/2−φ₁

A₁₂=β₁−π/2+φ₁

These two specific angular ranges are identified as the interface between the vertical cross-sectional area and the diagonal (from upper right to lower left) cross sectional area in FIG. 15. These conditions can be defined in one mathematical expression as:

$${A}_{{Q}_{4}} = \frac{1}{4} [ \frac{{δ}_{H V} - {A}_{1} + σ}{\vert {δ}_{H V} - {A}_{1} \vert + σ} + 1 ] \times [ \frac{{A}_{2} - {δ}_{H V} - σ}{\vert {A}_{2} - {δ}_{H V} \vert + σ} + 1 ] + \frac{1}{4} [ \frac{{δ}_{H V} - {A}_{11} + σ}{\vert {δ}_{H V} - {A}_{11} \vert + σ} + 1 ] \times [ \frac{{A}_{12} - {δ}_{H V} - σ}{\vert {A}_{12} - {δ}_{H V} \vert + σ} + 1 ]$$

The remote vehicle 14 is behind (XW=10) the host vehicle 10 if:

A₂≤δ_{HV}<2π or 0≤δ_{HV}<A₁₁

Where:

A₂=β₁+π/2+φ₁

A₁₁=β₁−π/2−φ₁

This region is identified as the vertical cross-sectional area in FIG. 15. These conditions can be defined in one mathematical expression as:

$${B}_{{Q}_{4}} = \frac{1}{4} [ \frac{{δ}_{H V} - 0 + σ}{\vert {δ}_{H V} - 0 \vert + σ} + 1 ] \times [ \frac{{A}_{11} - {δ}_{H V} - σ}{\vert {A}_{11} - {δ}_{H V} \vert + σ} + 1 ] + \frac{1}{4} [ \frac{{δ}_{H V} - {A}_{2} + σ}{\vert {δ}_{H V} - {A}_{2} \vert + σ} + 1 ] \times [ \frac{2 π - {δ}_{H V} - σ}{\vert 2 π - {δ}_{H V} \vert + σ} + 1 ]$$

### Lateral Position (VU)

The remote vehicle 14 is in lane (VU=00) with the host vehicle 10 if:

A₅≤δ_{HV}<A₆ or A₇≤δ_{HV}<A₈

### Where:

A₅=β₁−φ₂
A₆=β₁+φ₂
A₇=β₁+π−φ₂
A₈=β₁+π+φ₂
φ₂ is a threshold value that defines the angular range in which the remote vehicle 14 is defined to be in the same lane with the host vehicle 10
These two specific angular ranges are identified as the interface between the horizontal cross-sectional area and the diagonal (form upper left to lower right) cross sectional area in FIG. 16. These conditions can be defined in one mathematical expression as:

$${I}_{{Q}_{4}} = \frac{1}{4} [ \frac{{δ}_{H V} - {A}_{5} + σ}{\vert {δ}_{H V} - {A}_{5} \vert + σ} + 1 ] \times [ \frac{{A}_{6} - {δ}_{H V} - σ}{\vert {A}_{6} - {δ}_{H V} \vert + σ} + 1 ] + \frac{1}{4} [ \frac{{δ}_{H V} - {A}_{7} + σ}{\vert {δ}_{H V} - {A}_{7} \vert + σ} + 1 ] \times [ \frac{{A}_{8} - {δ}_{H V} - σ}{\vert {A}_{8} - {δ}_{H V} \vert + σ} + 1 ]$$

The remote vehicle 14 is to the left (VU=01) of the host vehicle 10 if:

A₆≤δ_{HV}<A₇

### Where:

A₆=β₁+φ₂
A₇=β₁+π−φ₂
This region is identified as the diagonal (form upper left to lower right) cross sectional area in FIG. 16. These conditions can be defined in one mathematical expression as:

$${L}_{{Q}_{4}} = \frac{1}{4} [ \frac{{δ}_{H V} - {A}_{6} + σ}{\vert {δ}_{H V} - {A}_{6} \vert + σ} + 1 ] \times [ \frac{{A}_{7} - {δ}_{H V} - σ}{\vert {A}_{7} - {δ}_{H V} \vert + σ} + 1 ]$$

The remote vehicle 14 is to the right (VU=10) of the host vehicle 10 if:

0≤δ_{HV}<A₅ or A₈≤δ_{HV}<2π

### Where:

A₅=β₁−φ₂
A₈=β₁+π+φ₂
This region is identified as the horizontal cross-sectional area in FIG. 16. These conditions can be defined in one mathematical expression as:

$${R}_{{Q}_{4}} = \frac{1}{4} [ \frac{{δ}_{H V} - 0 + σ}{\vert {δ}_{H V} - 0 \vert + σ} + 1 ] \times [ \frac{{A}_{5} - {δ}_{H V} - σ}{\vert {A}_{5} - {δ}_{H V} \vert + σ} + 1 ] + \frac{1}{4} [ \frac{{δ}_{H V} - {A}_{8} + σ}{\vert {δ}_{H V} - {A}_{8} \vert + σ} + 1 ] \times [ \frac{2 π - {δ}_{H V} - σ}{\vert 2 π - {δ}_{H V} \vert + σ} + 1 ]$$

The expressions are then consolidated in Table 4 for the case when the remote vehicle 14 is to the southwest of the host vehicle 10.

TABLE 4

| | | Lateral Position | | | |
|---|---|---|---|---|---|
| | | Remote vehicle | Remote vehicle | Remote vehicle | |
| Q₄ | | in lane (I_{Q}_{₄}) | Left (L_{Q}_{₄}) | Right (R_{Q}_{₄}) | Unused |
| Longitudinal | Remote vehicle | Q₄ × P_{Q}_{₄} × I_{Q}_{₄} | Q₄ × P_{Q}_{₄} × L_{Q}_{₄} | Q₄ × P_{Q}_{₄} × R_{Q}_{₄} | 0 |
| Position | Ahead (P_{Q}_{₄}) | | | | |
| | Remote vehicle | Q₄ × A_{Q}_{₄} × I_{Q}_{₄} | Q₄ × A_{Q}_{₄} × L_{Q}_{₄} | Q₄ × A_{Q}_{₄} × R_{Q}_{₄} | 0 |
| | Adjacent (A_{Q}_{₄}) | | | | |
| | Remote vehicle | Q₄ × B_{Q}_{₄} × I_{Q}_{₄} | Q₄ × B_{Q}_{₄} × L_{Q}_{₄} | Q₄ × B_{Q}_{₄} × R_{Q}_{₄} | 0 |
| | Behind (B_{Q}_{₄}) | | | | |
| | Unused | 0 | 0 | 0 | 0 |

### Summary (Tables 1-4)

TABLE 5

| | | Lateral Position | | | |
|---|---|---|---|---|---|
| | | Remote vehicle | Remote vehicle | Remote vehicle | |
| Q₁ | | in lane (I_{Q}_{₁}) | Left (L_{Q}_{₁}) | Right (R_{Q}_{₁}) | Unused |
| Longitudinal | Remote vehicle | Q₁ × P_{Q}_{₁} × I_{Q}_{₁} | Q₁ × P_{Q}_{₁} × L_{Q}_{₁} | Q₁ × P_{Q}_{₁} × R_{Q}_{₁} | 0 |
| Position | Ahead (P_{Q}_{₁}) | | | | |
| | Remote vehicle | Q₁ × A_{Q}_{₁} × I_{Q}_{₁} | Q₁ × A_{Q}_{₁} × L_{Q}_{₁} | Q₁ × A_{Q}_{₁} × R_{Q}_{₁} | 0 |
| | Adjacent (A_{Q}_{₁}) | | | | |
| | Remote vehicle | Q₁ × B_{Q}_{₁} × I_{Q}_{₁} | Q₁ × B_{Q}_{₁} × L_{Q}_{₁} | Q₁ × B_{Q}_{₁} × R_{Q}_{₁} | 0 |
| | Behind (B_{Q}_{₁}) | | | | |
| | Unused | 0 | 0 | 0 | 0 |
| | | Lateral Position | | | |
| | | Remote vehicle | Remote vehicle | Remote vehicle | |
| Q₂ | | in lane (I_{Q}_{₂}) | Left (L_{Q}_{₂}) | Right (R_{Q}_{₂}) | Unused |
| Longitudinal | Remote vehicle | Q₂ × P_{Q}_{₂} × I_{Q}_{₂} | Q₂ × P_{Q}_{₂} × L_{Q}_{₂} | Q₂ × P_{Q}_{₂} × R_{Q}_{₂} | 0 |
| Position | Ahead (P_{Q}_{₂}) | | | | |
| | Remote vehicle | Q₂ × A_{Q}_{₂} × I_{Q}_{₂} | Q₂ × A_{Q}_{₂} × L_{Q}_{₂} | Q₂ × A_{Q}_{₂} × R_{Q}_{₂} | 0 |
| | Adjacent (A_{Q}_{₂}) | | | | |
| | Remote vehicle | Q₂ × B_{Q}_{₂} × I_{Q}_{₂} | Q₂ × B_{Q}_{₂} × L_{Q}_{₂} | Q₂ × B_{Q}_{₂} × R_{Q}_{₂} | 0 |
| | Behind (B_{Q}_{₂}) | | | | |
| | Unused | 0 | 0 | 0 | 0 |
| | | Lateral Position | | | |
| | | Remote vehicle | Remote vehicle | Remote vehicle | |
| Q₃ | | in lane (I_{Q}_{₃}) | Left (L_{Q}_{₃}) | Right (R_{Q}_{₃}) | Unused |
| Longitudinal | Remote vehicle | Q₃ × P_{Q}_{₃} × I_{Q}_{₃} | Q₃ × P_{Q}_{₃} × L_{Q}_{₃} | Q₃ × P_{Q}_{₃} × R_{Q}_{₃} | 0 |
| Position | Ahead (P_{Q}_{₃}) | | | | |
| | Remote vehicle | Q₃ × A_{Q}_{₃} × I_{Q}_{₃} | Q₃ × A_{Q}_{₃} × L_{Q}_{₃} | Q₃ × A_{Q}_{₃} × R_{Q}_{₃} | 0 |
| | Adjacent (A_{Q}_{₃}) | | | | |
| | Remote vehicle | Q₃ × B_{Q}_{₃} × I_{Q}_{₃} | Q₃ × B_{Q}_{₃} × L_{Q}_{₃} | Q₃ × B_{Q}_{₃} × R_{Q}_{₃} | 0 |
| | Behind (B_{Q}_{₃}) | | | | |
| | Unused | 0 | 0 | 0 | 0 |
| | | Lateral Position | | | |
| | | Remote vehicle | Remote vehicle | Remote vehicle | |
| Q₄ | | in lane (I_{Q}_{₄}) | Left (L_{Q}_{₄}) | Right (R_{Q}_{₄}) | Unused |
| Longitudinal | Remote vehicle | Q₄ × P_{Q}_{₄} × I_{Q}_{₄} | Q₄ × P_{Q}_{₄} × L_{Q}_{₄} | Q₄ × P_{Q}_{₄} × R_{Q}_{₄} | 0 |
| Position | Ahead (P_{Q}_{₄}) | | | | |
| | Remote vehicle | Q₄ × A_{Q}_{₄} × I_{Q}_{₄} | Q₄ × A_{Q}_{₄} × L_{Q}_{₄} | Q₄ × A_{Q}_{₄} × R_{Q}_{₄} | 0 |
| | Adjacent (A_{Q}_{₄}) | | | | |
| | Remote vehicle | Q₄ × B_{Q}_{₄} × I_{Q}_{₄} | Q₄ × B_{Q}_{₄} × L_{Q}_{₄} | Q₄ × B_{Q}_{₄} × R_{Q}_{₄} | 0 |
| | Behind (B_{Q}_{₄}) | | | | |
| | Unused | 0 | 0 | 0 | 0 |

The longitudinal and lateral relative position bits for the relative position code are defined in Table 6:

TABLE 6

| | | VU | | | |
|---|---|---|---|---|---|
| | | 00 | 01 | 10 | 11 |
| XW | 00 | 0000 | 0001 | 0010 | 0011 |
| | 01 | 0100 | 0101 | 0110 | 0111 |
| | 10 | 1000 | 1001 | 1010 | 1011 |
| | 11 | 1100 | 1101 | 1110 | 1111 |

Bits X through U are generated using the array of expressions shown in Table 7

TABLE 7

| x | w | v | u |
|---|---|---|---|
| x₁ = 0 | w₁ = 0 | v₁ = 0 | u₁ = 0 |
| x₂ = 0 | w₂ = 0 | v₂ = 0 | ${u}_{2} = {\sum }_{i = 1}^{4} {Q}_{i} \times {P}_{{Q}_{i}} \times {L}_{{Q}_{i}} \times 1$ |
| x₃ = 0 | w₃ = 0 | ${v}_{3} = {\sum }_{i = 1}^{4} {Q}_{i} \times {P}_{{Q}_{i}} \times {R}_{{Q}_{i}} \times 1$ | u₃ = 0 |
| x₄ = 0 | ${w}_{4} = {\sum }_{i = 1}^{4} {Q}_{i} \times {A}_{{Q}_{i}} \times {I}_{{Q}_{i}} \times 1$ | v₄ = 0 | u₄ = 0 |
| x₅ = 0 | ${w}_{5} = {\sum }_{i = 1}^{4} {Q}_{i} \times {A}_{{Q}_{i}} \times {I}_{{Q}_{i}} \times 1$ | v₅ = 0 | ${u}_{5} = {\sum }_{i = 1}^{4} {Q}_{i} \times {A}_{{Q}_{i}} \times {L}_{{Q}_{i}} \times 1$ |
| x₆ = 0 | ${w}_{6} = {\sum }_{i = 1}^{4} {Q}_{i} \times {A}_{{Q}_{i}} \times {R}_{{Q}_{i}} \times 1$ | ${v}_{6} = {\sum }_{i = 1}^{4} {Q}_{i} \times {A}_{{Q}_{i}} \times {R}_{{Q}_{i}} \times 1$ | u₆ = 0 |
| ${x}_{7} = {\sum }_{i = 1}^{4} {Q}_{i} \times {B}_{{Q}_{i}} \times {I}_{{Q}_{i}} \times 1$ | w₇ = 0 | v₇ = 0 | u₇ = 0 |
| ${x}_{8} = {\sum }_{i = 1}^{4} {Q}_{i} \times {B}_{{Q}_{i}} \times {L}_{{Q}_{i}} \times 1$ | w₈ = 0 | v₈ = 0 | ${u}_{8} = {\sum }_{i = 1}^{4} {Q}_{i} \times {B}_{{Q}_{i}} \times {L}_{{Q}_{i}} \times 1$ |
| ${x}_{9} = {\sum }_{i = 1}^{4} {Q}_{i} \times {B}_{{Q}_{i}} \times {R}_{{Q}_{i}} \times 1$ | w₉ = 0 | ${v}_{9} = {\sum }_{i = 1}^{4} {Q}_{i} \times {B}_{{Q}_{i}} \times {R}_{{Q}_{i}} \times 1$ | u₉ = 0 |
| $X = {\sum }_{i = 1}^{9} {x}_{i}$ | $W = {\sum }_{i = 1}^{9} {w}_{i}$ | $V = {\sum }_{i = 1}^{9} {v}_{i}$ | $U = {\sum }_{i = 1}^{9} {u}_{i}$ |

### Elevation

The elevation component of relative position is easily provided by the following three expressions.

If the host vehicle 10 and remote vehicle 14 are at the same elevation,

$${Z}_{1} = \frac{1}{4} [ \frac{ɛ - ( {z}_{HV} - {z}_{R V} ) + σ}{\vert ɛ - ( {z}_{HV} - {z}_{R V} ) \vert + σ} + 1 ] \times [ \frac{ɛ - ( {z}_{RV} - {z}_{HV} ) - σ}{\vert ɛ - ( {z}_{RV} - {z}_{HV} ) \vert + σ} + 1 ] = 1 ( T S = 00 )$$

If the host vehicle 10 is lower,

$${Z}_{2} = \frac{1}{2} [ \frac{( {z}_{R V} - {z}_{W} ) - ɛ - σ}{\vert ( {z}_{R V} - {z}_{J W} ) - ɛ \vert + σ} + 1 ] = 1 ( TS = 01 )$$

If the host vehicle 10 is higher,

$${Z}_{3} = \frac{1}{2} [ \frac{( {z}_{HV} - {z}_{R V} ) - ɛ - σ}{\vert ( {z}_{HV} - {z}_{R V} ) - ɛ \vert + σ} + 1 ] = 1 ( TS = 10 )$$

where:
Z_{host vehicle}=host vehicle 10 elevation
Z_{remote vehicle}=remote vehicle 14 elevation
£=a defined threshold value of distance such as 4 m.
Bits T and S U are generated using the array of expressions shown in Table 8.

TABLE 8

| t | s |
|---|---|
| t₁ = Z₁ × 0 | s₁ = Z₁ × 0 |
| t₂ = Z₂ × 0 | s₂ = Z₂ × 1 |
| t₃ = Z₃ × 1 | s₃ = Z₃ × 0 |

$$T = {\sum }_{i = 1}^{3} {t}_{i}$$

$$S = {\sum }_{i = 1}^{3} {s}_{i}$$

### Remote Vehicle Position Relative to Host Vehicle (Heading)

When the host vehicle 10 and the remote vehicle 14 traveling in same direction, (RQ=01). The remote vehicle 14 heading angle as a function of the host vehicle 10 heading angle for the case of following vehicles can be defined as follows: δ_{RV}=δ_{HV}

However, narrowly defining δ_{remote vehicle} to be exactly the same as δ_{host vehicle} would result in a condition where the two vehicles would almost never be classified as heading in the same direction when in reality this condition is a very common occurrence. In order to account for small differences in heading angles, a variable φ₂ is used to define a range of heading angles for the remote vehicle 14 in which the remote vehicle 14 would be considered to be heading in the same direction as the host vehicle 10. To define this range, the following expressions are defined.

Minimum Remote Vehicle Heading Angle

If δ_{RV}−φ₂ then δ_{RV}_{ₘᵢₙ}⁰¹=2π+δ_{RV}−φ₂

If δ_{RV}−φ₂≥0 then δ_{RV}_{ₘᵢₙ}⁰¹=δ_{RV}−φ₂
These conditions can be combined into one mathematical expression as:

δ_{RV}_{ₘᵢₙ}⁰¹=ζₘᵢₙ_{₁}×(2π+δ_{RV}−φ₂)+ζₘᵢₙ_{₂}×(δ_{RV}−φ₂)

### Where:

$${ϛ}_{{min}_{1}} = \frac{1}{2} [ \frac{0 - ( {δ}_{RV} - {ϕ}_{2} ) - σ}{\vert 0 - ( {δ}_{RV} - {ϕ}_{2} ) \vert + σ} + 1 ]$$

$${ϛ}_{{min}_{2}} = \frac{1}{2} [ \frac{( {δ}_{RV} - ϕ ) - 0 + σ}{\vert ( {δ}_{RV} - ϕ ) - 0 \vert + σ} + 1 ]$$

These expressions have two values, 0 or 1 depending on the value of δ_{remote vehicle} and can be thought of as filtering functions that ensure the appropriate expression is used to calculate the value of δ_{RV}_{ₘᵢₙ}⁰¹.

### Maximum Remote Vehicle Heading Angle

If δ_{RV}+φ<2π then δ_{RV}_{ₘₐₓ}⁰¹=δ_{RV}+φ₂

If δ_{RV}+φ≥2π then δ_{RV}_{ₘₐₓ}⁰¹=δ_{RV}+φ₂−2π

These conditions can be combined into one mathematical expression as:

δ_{RV}_{ₘₐₓ}⁰¹=ζₘₐₓ_{₁}×(δ_{RV}+φ₂)+ζₘₐₓ_{₂}×(δ_{RV}+φ₂−2π)

### Where:

$${ϛ}_{{max}_{1}} = \frac{1}{2} [ \frac{2 π - ( {δ}_{RV} + {ϕ}_{2} ) - σ}{\vert 2 π - ( {δ}_{RV} + {ϕ}_{2} ) \vert + σ} + 1 ]$$

$${ϛ}_{{max}_{2}} = \frac{1}{2} [ \frac{( {δ}_{RV} + {ϕ}_{2} ) - 2 π + σ}{\vert ( {δ}_{RV} + {ϕ}_{2} ) - 2 π \vert + σ} + 1 ]$$

These expressions have two values, 0 or 1 depending on the value of δ_{remote vehicle} and can be thought of as filtering functions that ensure the appropriate expression is used to calculate the value of δ_{RV}_{ₘₐₓ}⁰¹.

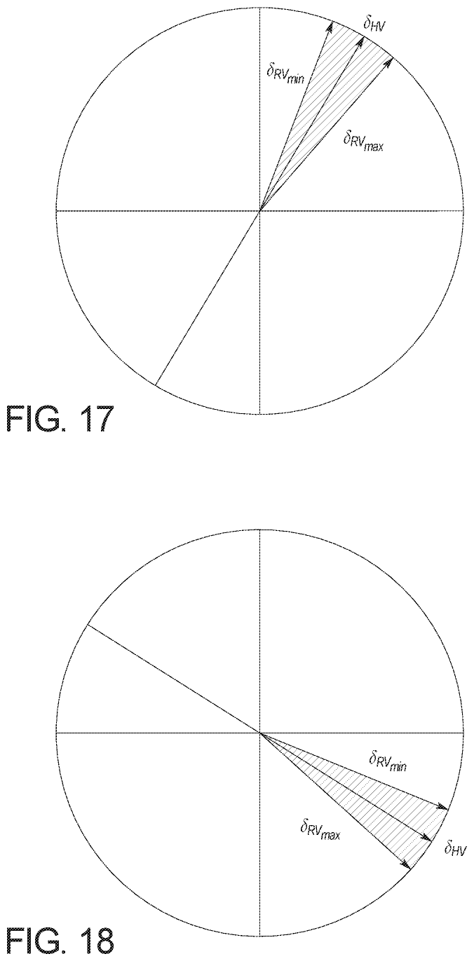

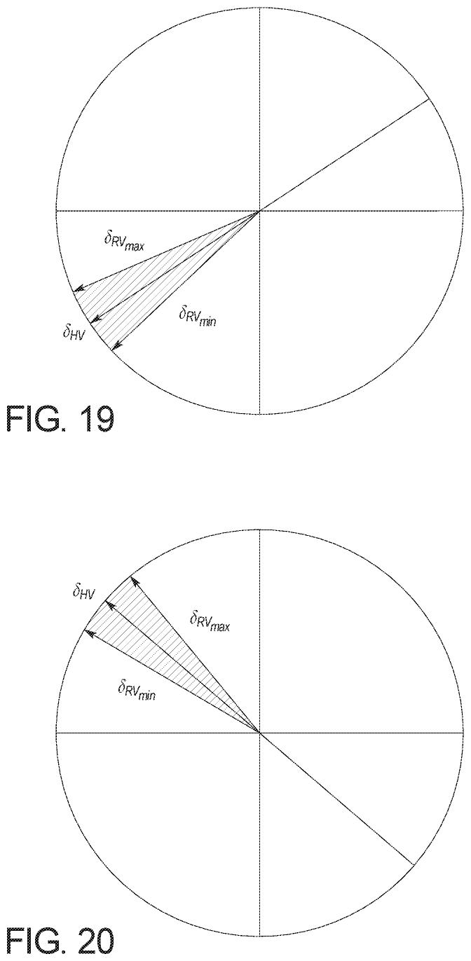

The remote vehicle 14 is considered to be traveling in the same direction as the host vehicle 10 when the heading angle of the remote vehicle 14, δ_{remote vehicle} falls within the range δ_{RV}_{ₘᵢₙ}⁰¹ and δ_{RV}_{ₘₐₓ}⁰¹ therefore in most cases, the heading angle of the host vehicle 10, δ_{host vehicle} will be greater than or equal to δ_{RV}_{ₘᵢₙ}⁰¹ and less than or equal to δ_{RV}_{ₘₐₓ}⁰¹ otherwise the remote vehicle 14 will be considered to be traveling in a direction other than the same direction of the host vehicle 10 as shown in FIGS. 17-20.

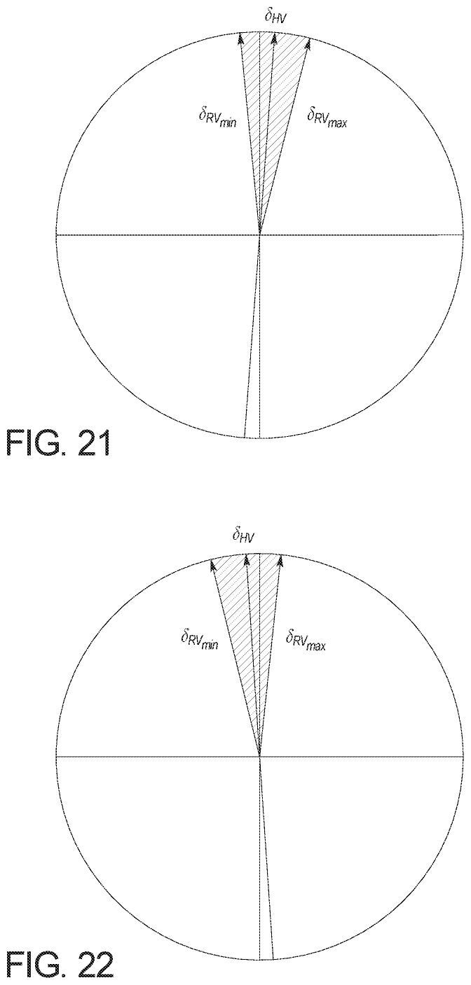

However, because of the fixed reference used where North=0°, there are cases where δ_{host vehicle} will be less than or equal to δ_{RV}_{ₘᵢₙ}⁰¹ and less than or equal to δ_{RV}_{ₘₐₓ}⁰¹ or cases where δ_{host vehicle} will be greater than or equal to δ_{RV}_{ₘᵢₙ}⁰¹ and greater than or equal to δ_{RV}_{ₘₐₓ}⁰¹ such as shown in FIGS. 21 and 22.

Consider the following expressions for H₁ and H₂.

H₁=δ_{HV}−δ_{RV}_{ₘᵢₙ}⁰¹

H₂=δ_{HV}−δ_{RV}_{ₘₐₓ}⁰¹

For any value of δ_{host vehicle}, the values for H₁ and H₂ fall within three distinct categories:
1: H₁ is negative, H₂ is negative and H₁<H₂ (δ_{HV}<δ_{RV}_{ₘᵢₙ}⁰¹ and δ_{HV}<δ_{RV}_{ₘₐₓ}⁰¹)
2: H₁ is positive, H₂ is negative and H₁>H₂ (δ_{HV}>δ_{RV}_{ₘᵢₙ}⁰¹ and δ_{HV}<δ_{RV}_{ₘₐₓ}⁰¹)
3: H₁ is positive, H₂ is positive and H₁<H₂ (δ_{HV}>δ_{RV}_{ₘᵢₙ}⁰¹ and δ_{HV}>δ_{RV}_{ₘₐₓ}⁰¹)
From these three conditions, it can be shown that for any combination of δ_{host vehicle} and δ_{remote vehicle}, where 0≤δ_{HV}<2π and 0≤δ_{RV}<2π the following expressions can be used to identify if the host vehicle 10 and remote vehicle 14 are traveling in the same direction.

$${Δ}_{1}^{01} = \frac{1}{8} [ \frac{{δ}_{{RV}_{min}}^{01} - {δ}_{RV} + σ}{\vert {δ}_{{RV}_{min}}^{01} - {δ}_{RV} \vert + σ} + 1 ] \times [ \frac{{δ}_{{RV}_{max}}^{01} - {δ}_{RV} + σ}{\vert {δ}_{{RV}_{max}}^{01} - {δ}_{RV} \vert + σ} + 1 ] \times [ 1 - \frac{{H}_{1} - {H}_{2} - σ}{\vert {H}_{1} - {H}_{2} \vert + σ} ]$$

If H₁<H₂, δ_{RV}≤δ_{RV}_{ₘᵢₙ}⁰¹, and δ_{RV}≤δ_{RV}_{ₘₐₓ}⁰¹ Δ₁⁰¹=1 otherwise Δ₁⁰¹=0

$${Δ}_{2}^{01} = \frac{1}{8} [ \frac{{δ}_{RV} - {δ}_{{RV}_{min}}^{01} + σ}{\vert {δ}_{RV} - {δ}_{{RV}_{min}}^{01} \vert + σ} + 1 ] \times [ \frac{{δ}_{{RV}_{max}}^{01} - {δ}_{RV} + σ}{\vert {δ}_{{RV}_{max}}^{01} - {δ}_{RV} \vert + σ} + 1 ] \times [ \frac{{H}_{1} - {H}_{2} - σ}{\vert {H}_{1} - {H}_{2} \vert + σ} + 1 ]$$

If H₁>H₂ and δ_{RV}_{ₘᵢₙ}⁰¹≤δ_{RV}≤δ_{RV}_{ₘₐₓ}⁰¹, Δ₂⁰¹=1 otherwise Δ₂⁰¹=0

$${Δ}_{3}^{01} = \frac{1}{8} [ \frac{{δ}_{RV} - {δ}_{{RV}_{min}}^{01} + σ}{\vert {δ}_{RV} - {δ}_{{RV}_{min}}^{01} \vert + σ} + 1 ] \times [ \frac{{δ}_{RV} - {δ}_{{RV}_{max}}^{01} + σ}{\vert {δ}_{RV} - {δ}_{{RV}_{max}}^{01} \vert + σ} + 1 ] \times [ 1 - \frac{{H}_{1} - {H}_{2} - σ}{\vert {H}_{1} - {H}_{2} \vert + σ} ]$$

If H₁<H₂ and δ_{RV}_{ₘᵢₙ}⁰¹≤δ_{RV} and δ_{RV}_{ₘₐₓ}⁰¹≤δ_{RV} Δ₁⁰¹=1 otherwise Δ₁⁰¹=0
Also, it is advantageous to define the difference of H₁ and H₂ as follows:

H₁−H₂=δ_{HV}−δ_{RV}_{ₘᵢₙ}⁰¹−(δ_{HV}−δ_{RV}_{ₘₐₓ}⁰¹)

H₁−H₂=δ_{HV}−δ_{RV}_{ₘᵢₙ}⁰¹−δ_{HV}+δ_{RV}_{ₘₐₓ}⁰¹

H₁−H₂=δ_{HV}−δ_{RV}_{ₘᵢₙ}⁰¹−δ_{HV}+δ_{RV}_{ₘₐₓ}⁰¹

H₁−H₂=δ_{RV}_{ₘₐₓ}⁰¹−δ_{RV}_{ₘᵢₙ}⁰¹,

Then the previous expressions can be expressed as:

$${Δ}_{1}^{01} = \frac{1}{8} [ \frac{{δ}_{{RV}_{min}}^{01} - {δ}_{RV} + σ}{\vert {δ}_{{RV}_{min}}^{01} - {δ}_{RV} \vert + σ} + 1 ] \times [ \frac{{δ}_{{RV}_{max}}^{01} - {δ}_{RV} + σ}{\vert {δ}_{{RV}_{max}}^{01} - {δ}_{RV} \vert + σ} + 1 ] \times [ 1 - \frac{{δ}_{{RV}_{max}}^{01} - {δ}_{{RV}_{min}}^{01} - σ}{\vert {δ}_{{RV}_{max}}^{01} - {δ}_{{RV}_{min}}^{01} \vert + σ} ] \\ {Δ}_{2}^{01} = \frac{1}{8} [ \frac{{δ}_{RV} - {δ}_{{RV}_{min}}^{01} + σ}{\vert {δ}_{RV} - {δ}_{{RV}_{min}}^{01} \vert + σ} + 1 ] \times [ \frac{{δ}_{{RV}_{max}}^{01} - {δ}_{RV} + σ}{\vert {δ}_{{RV}_{max}}^{01} - {δ}_{RV} \vert + σ} + 1 ] \times [ \frac{{δ}_{{RV}_{max}}^{01} - {δ}_{{RV}_{min}}^{01} - σ}{\vert {δ}_{{RV}_{max}}^{01} - {δ}_{{RV}_{min}}^{01} \vert + σ} + 1 ] \\ {Δ}_{3}^{01} = \frac{1}{8} [ \frac{{δ}_{RV} - {δ}_{{RV}_{min}}^{01} + σ}{\vert {δ}_{RV} - {δ}_{{RV}_{min}}^{01} \vert + σ} + 1 ] \times [ \frac{{δ}_{RV} - {δ}_{{RV}_{max}}^{01} + σ}{\vert {δ}_{RV} - {δ}_{{RV}_{max}}^{01} \vert + σ} + 1 ] \times [ 1 - \frac{{δ}_{{RV}_{max}}^{01} - {δ}_{{RV}_{min}}^{01} - σ}{\vert {δ}_{{RV}_{max}}^{01} - {δ}_{{RV}_{min}}^{01} \vert + σ} ]$$

If the sum of these three expressions is equal to 1, the host vehicle 10 and remote vehicle 14 are traveling in the same direction. This condition is expressed mathematically as:

$${\sum }_{i = 1}^{3} {Δ}_{i}^{01} = 1 ( RQ = 01 )$$

### Thus:

$${r}_{1} = {\sum }_{i = 1}^{3} {Δ}_{i}^{01} \times 0$$

$${q}_{1} = {\sum }_{i = 1}^{3} {Δ}_{i}^{01} \times 1$$

host vehicle 10 and remote vehicle 14 approaching either other from opposite directions (RQ=10):
Remote vehicle 14 Heading angle as a function of Host vehicle 10 heading angle for the case of on-coming vehicles can be defined as follows:

$${δ}_{RV} = \frac{1}{2} [ \frac{{δ}_{HV} - π - σ}{\vert {δ}_{HV} - π \vert + σ} + 1 ] \times ( {δ}_{HV} - π ) + \frac{1}{2} [ \frac{π - {δ}_{HV} - σ}{\vert π - {δ}_{HV} \vert + σ} + 1 ] \times ( {δ}_{HV} + π )$$

However, narrowly defining δ_{remote vehicle} to be exactly opposite of δ_{host vehicle} would result in a condition where the two vehicles would almost never be classified as heading in opposite direction when in reality this condition is a very common occurrence. In order to account for small differences in heading angles, the variable φ₂ is used to define a range of heading angles for the remote vehicle 14 in which the remote vehicle 14 would be considered to be heading in the opposite direction of the host vehicle 10. To define this range, the following expressions are defined:

### Minimum Remote Vehicle Heading Angle:

If δ_{RV}−φ₂<0 then δ_{RV}_{ₘᵢₙ}¹⁰=2π+δ_{RV}−φ₂
If δ_{RV}−φ₂≥0 then δ_{RV}_{ₘᵢₙ}¹⁰=δ_{RV}−φ₂ These conditions can be combined into one mathematical expression as:

δ_{RV}_{ₘᵢₙ}¹⁰=ζₘᵢₙ_{₁}×(2π+δ_{RV}−φ₂)+ζₘᵢₙ_{₂}×(δ_{RV}−φ₂)

### Where:

$${ϛ}_{{min}_{1}} = \frac{1}{2} [ \frac{0 - ( {δ}_{RV} - {ϕ}_{2} ) - σ}{\vert 0 - ( {δ}_{RV} - {ϕ}_{2} ) \vert + σ} + 1 ]$$

$${ϛ}_{{min}_{2}} = \frac{1}{2} [ \frac{( {δ}_{RV} - ϕ ) - 0 + σ}{\vert ( {δ}_{RV} - ϕ ) - 0 \vert + σ} + 1 ]$$

These expressions have two values, 0 or 1 depending on the value of δ_{remote vehicle} and can be thought of as filtering functions that ensure the appropriate expression is used to calculate the value of δ_{RV}_{ₘᵢₙ}¹⁰.

### Maximum Remote Vehicle Heading Angle

If δ_{RV}+φ₂<2π then δ_{RV}_{ₘₐₓ}¹⁰=δ_{RV}+φ₂

If δ_{RV}+φ₂≥2π then δ_{RV}_{ₘₐₓ}¹⁰=δ_{RV}+φ₂−2π

These conditions can be combined into one mathematical expression as:

δ_{RV}_{ₘₐₓ}¹⁰=ζₘₐₓ_{₁}×(δ_{RV}+φ₂)+ζₘₐₓ_{₂}×(δ_{RV}+φ₂−2π)

where:

$${ϛ}_{{max}_{1}} = \frac{1}{2} [ \frac{2 π - ( {δ}_{RV} + {ϕ}_{2} ) - σ}{\vert 2 π - ( {δ}_{RV} + {ϕ}_{2} ) \vert + σ} + 1 ]$$

$${ϛ}_{{max}_{2}} = \frac{1}{2} [ \frac{( {δ}_{RV} + {ϕ}_{2} ) - 2 π + σ}{\vert ( {δ}_{RV} + {ϕ}_{2} ) - 2 π \vert + σ} + 1 ]$$

These expressions have two values, 0 or 1 depending on the value of δ_{remote vehicle} and can be thought of as filtering functions that ensure the appropriate expression is used to calculate the value of δ_{RV}_{ₘₐₓ}¹⁰.

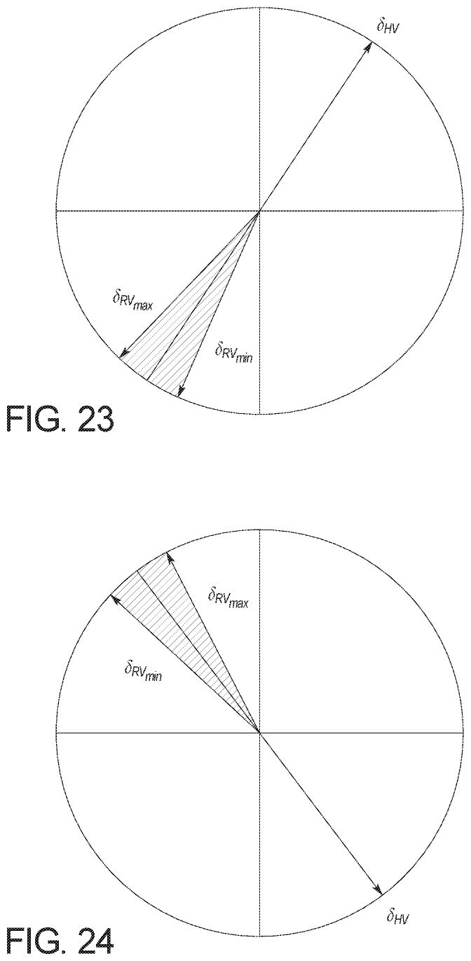

The remote vehicle 14 is considered to be traveling in the direction opposite of the host vehicle 10 when the heading angle of the remote vehicle 14, δ_{remote vehicle} falls within the range δ_{RV}_{ₘᵢₙ}¹⁰ and δ_{RV}_{ₘₐₓ}¹⁰ therefore cases exist where the heading angle of the host vehicle 10, δ_{host vehicle} will be less than δ_{RV}_{ₘᵢₙ}¹⁰ and less than δ_{RV}_{ₘₐₓ}¹⁰ when δ_{host vehicle} is less than π as shown in FIGS. 23 and 24.

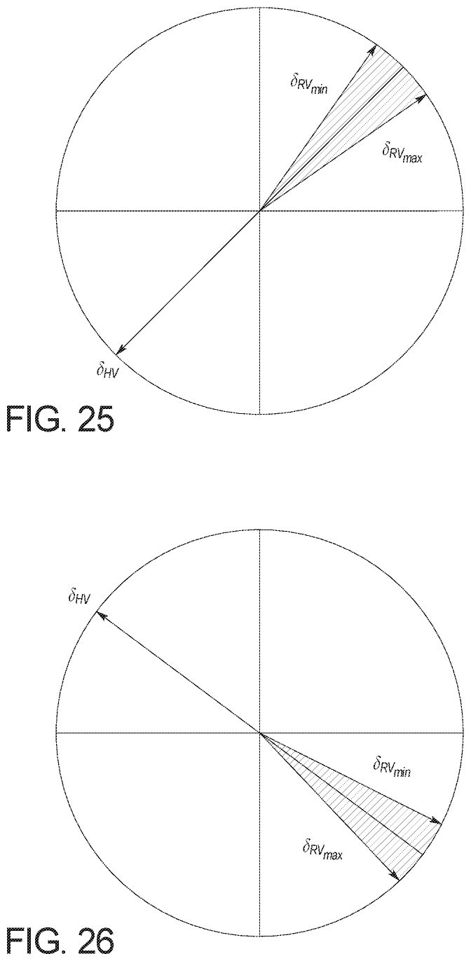

There also exist cases where δ_{host vehicle} will be greater than δ_{RV}_{ₘᵢₙ}¹⁰ and greater than δ_{RV}_{ₘₐₓ}¹⁰ when δ_{host vehicle} is greater than π otherwise the remote vehicle 14 will be considered to be traveling in a direction other than the opposite direction of the host vehicle 10 as shown in FIGS. 25 and 26.

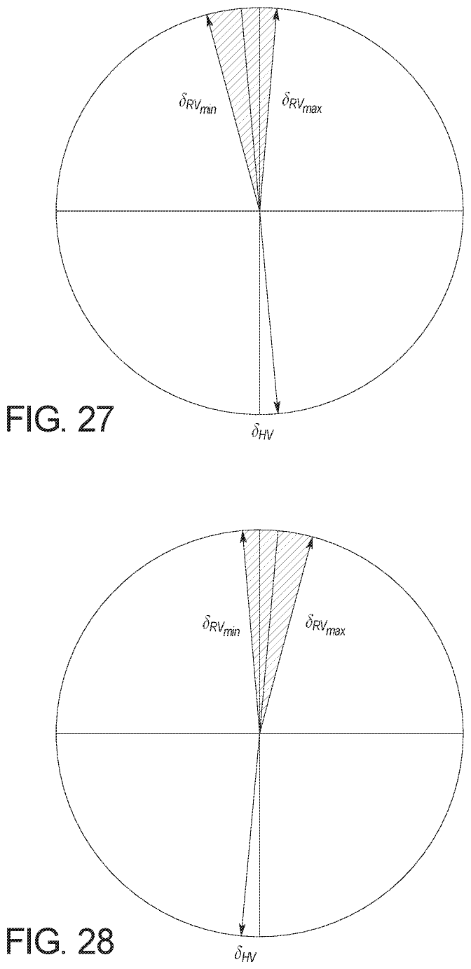

However, because of the fixed reference used where North=0°, there are cases where δ_{host vehicle} will be less than δ_{RV}_{ₘᵢₙ}¹⁰ and greater than δ_{RV}_{ₘₐₓ}¹⁰ when δ_{host vehicle} is less than or greater than π such as FIGS. 27 and 28.

Consider the following expressions for H₁ and H₂.

H₁=δ_{HV}−δ_{RV}_{ₘᵢₙ}¹⁰

H₂=δ_{HV}−δ_{RV}_{ₘₐₓ}¹⁰

For any value of δ_{host vehicle}, the values for H₁ and H₂ fall within three distinct categories:
1: H₁ is negative, H₂ is negative and H₁>H₂ (δ_{HV}<δ_{RV}_{ₘᵢₙ}¹⁰ and δ_{HV}<δ_{RV}_{ₘₐₓ}¹⁰)
2: H₁ is negative, H₂ is positive and H₁<H₂ (δ_{HV}<δ_{RV}_{ₘᵢₙ}¹⁰ and δ_{HV}>δ_{RV}_{ₘₐₓ}¹⁰)
3: H₁ is positive, this positive and H₁>H₂ (δ_{HV}>δ_{RV}_{ₘᵢₙ}¹⁰ and δ_{HV}<δ_{RV}_{ₘₐₓ}¹⁰)
From these three conditions, it can be shown that for any combination of δ_{host vehicle} and δ_{remote vehicle}, where 0≤δ_{HV}<2π and 0≤R_{RV}<2π the following expressions can be used to identify if the host vehicle 10 and remote vehicle 14 are traveling in opposite directions.

$${Δ}_{1}^{10} = \frac{1}{8} [ \frac{{δ}_{RV} - {δ}_{{RV}_{min}}^{10} + σ}{\vert {δ}_{RV} - {δ}_{{RV}_{min}}^{10} \vert + σ} + 1 ] \times [ \frac{{δ}_{{RV}_{max}}^{10} - {δ}_{RV} + σ}{\vert {δ}_{{RV}_{max}}^{10} - {δ}_{RV} \vert + σ} + 1 ] \times [ \frac{{H}_{1} - {H}_{2} - σ}{\vert {H}_{1} - {H}_{2} \vert + σ} + 1 ]$$

If H₁>H₂ and δ_{RV}_{ₘᵢₙ}¹⁰≤δ_{RV}≤δ_{RV}_{ₘₐₓ}¹⁰, Δ₁¹⁰=1 otherwise Δ₁¹⁰=0

$${Δ}_{2}^{10} = \frac{1}{8} [ \frac{{δ}_{RV} - {δ}_{{RV}_{min}}^{10} + σ}{\vert {δ}_{RV} - {δ}_{{RV}_{min}}^{10} \vert + σ} + 1 ] \times [ \frac{{δ}_{RV} - {δ}_{{RV}_{max}}^{10} + σ}{\vert {δ}_{RV} - {δ}_{{RV}_{max}}^{10} \vert + σ} + 1 ] \times [ 1 - \frac{{H}_{1} - {H}_{2} - σ}{\vert {H}_{1} - {H}_{2} \vert + σ} ]$$

If H₁<H₂, δ_{RV}_{ₘᵢₙ}¹⁰≥δ_{RV} and δ_{RV}_{ₘₐₓ}¹⁰≥δ_{RV}, Δ₂¹⁰=1 otherwise Δ₂¹⁰=0

$${Δ}_{3}^{10} = \frac{1}{8} [ \frac{{δ}_{{RV}_{min}}^{10} - {δ}_{RV} + σ}{\vert {δ}_{{RV}_{min}}^{10} - {δ}_{RV} \vert + σ} + 1 ] \times [ \frac{{δ}_{{RV}_{max}}^{10} - {δ}_{RV} + σ}{\vert {δ}_{{RV}_{max}}^{10} - {δ}_{RV} \vert + σ} + 1 ] \times [ 1 - \frac{{H}_{1} - {H}_{2} - σ}{\vert {H}_{1} - {H}_{2} \vert + σ} ]$$

If H₁<H₂, δ_{RV}≤δ_{RV}_{ₘᵢₙ}¹⁰ and δ_{RV}≤δ_{RV}_{ₘₐₓ}¹⁰, Δ₃¹⁰=1 otherwise Δ₃¹⁰=0

Also, it is advantageous to define the difference of H₁ and H₂ as follows:

H₁−H₂=δ_{HV}−β_{RV}_{ₘᵢₙ}¹⁰−(δ_{HV}−δ_{RV}_{ₘₐₓ}¹⁰)

H₁−H₂=δ_{HV}−β_{RV}_{ₘᵢₙ}¹⁰−δ_{HV}+δ_{RV}_{ₘₐₓ}¹⁰)

H₁−H₂=δ_{HV}−β_{RV}_{ₘᵢₙ}¹⁰−δ_{HV}+δ_{RV}_{ₘₐₓ}¹⁰

H₁−H₂=δ_{RV}_{ₘₐₓ}¹⁰−δ_{RV}_{ₘᵢₙ}¹⁰

Then the previous expressions can be expressed as:

$${Δ}_{1}^{10} = \frac{1}{8} [ \frac{{δ}_{RV} - {δ}_{{RV}_{min}}^{10} + σ}{\vert {δ}_{RV} - {δ}_{{RV}_{min}}^{10} \vert + σ} + 1 ] \times [ \frac{{δ}_{{RV}_{max}}^{10} - {δ}_{RV} + σ}{\vert {δ}_{{RV}_{max}}^{10} - {δ}_{RV} \vert + σ} + 1 ] \times [ \frac{{δ}_{{RV}_{max}}^{10} - {δ}_{{RV}_{min}}^{10} - σ}{\vert {δ}_{{RV}_{max}}^{10} - {δ}_{{RV}_{min}}^{10} \vert + σ} + 1 ] \\ {Δ}_{2}^{10} = \frac{1}{8} [ \frac{{δ}_{RV} - {δ}_{{RV}_{min}}^{10} + σ}{\vert {δ}_{RV} - {δ}_{{RV}_{min}}^{10} \vert + σ} + 1 ] \times [ \frac{{δ}_{RV} - {δ}_{{RV}_{max}}^{10} + σ}{\vert {δ}_{RV} - {δ}_{{RV}_{max}}^{10} \vert + σ} + 1 ] \times [ 1 - \frac{{δ}_{{RV}_{max}}^{10} - {δ}_{{RV}_{min}}^{10} - σ}{\vert {δ}_{{RV}_{max}}^{10} - {δ}_{{RV}_{min}}^{10} \vert + σ} ] \\ {Δ}_{3}^{10} = \frac{1}{8} [ \frac{{δ}_{{RV}_{min}}^{10} - {δ}_{RV} + σ}{\vert {δ}_{{RV}_{min}}^{10} - {δ}_{RV} \vert + σ} + 1 ] \times [ \frac{{δ}_{{RV}_{max}}^{10} - {δ}_{RV} + σ}{\vert {δ}_{{RV}_{max}}^{10} - {δ}_{RV} \vert + σ} + 1 ] \times [ 1 - \frac{{δ}_{{RV}_{max}}^{10} - {δ}_{{RV}_{min}}^{10} - σ}{\vert {δ}_{{RV}_{max}}^{10} - {δ}_{{RV}_{min}}^{10} \vert + σ} ]$$

By summing these three expressions, it can be determined that the host vehicle 10 and remote vehicle 14 are approaching each other from opposite directions if:

$${\sum }_{i = 1}^{3} {Δ}_{i}^{10} = 1 ( RQ = 10 )$$

### Thus:

$${r}_{2} = {\sum }_{i = 1}^{3} {Δ}_{i}^{10} \times 1$$

$${q}_{2} = {\sum }_{i = 1}^{3} {Δ}_{i}^{10} \times 0$$

host vehicle 10 and remote vehicle 14 approaching from crossing directions (RQ=11) When the remote vehicle 14 and host vehicle 10 approach each other from directions that result in a crossing path, the remote vehicle 14 heading angle, δ_{remote vehicle} can be defined as a function of host vehicle 10 heading angle, δ_{host vehicle} according to the following expressions. Since a crossing path can occur if the remote vehicle 14 approaches from the left or right, a total of four angles must be defined; minimum and maximum angles for the left and minimum and maximum angle for the right. If δ_{remote vehicle} falls within the two ranges, a crossing path exists.

Remote vehicle 14 Heading angle as a function of Host vehicle 10 heading angle for the case of vehicles crossing paths can be defined as follows:

### Minimum Remote Vehicle Heading Angle

$${δ}_{{RV}_{min L}}^{11} = \frac{1}{4} [ \frac{{δ}_{HV} - 0 + σ}{\vert {δ}_{HV} - 0 \vert + σ} + 1 ] \times [ \frac{{ϕ}_{6} - {δ}_{HV} - σ}{\vert {ϕ}_{6} - {δ}_{HV} \vert + σ} + 1 ] \times ( {δ}_{HV} + {ϕ}_{3} ) + \frac{1}{4} [ \frac{{δ}_{HV} - {ϕ}_{6} + σ}{\vert {δ}_{HV} - {ϕ}_{6} \vert + σ} ] \times [ \frac{2 π - {δ}_{HV} - σ}{\vert 2 π - {δ}_{HV} \vert + σ} + 1 ] \times ( {δ}_{HV} - {ϕ}_{6} )$$

$${δ}_{{RV}_{min R}}^{11} = \frac{1}{4} [ \frac{{δ}_{HV} - 0 + σ}{\vert {δ}_{HV} - 0 \vert + σ} + 1 ] \times [ \frac{{ϕ}_{4} - {δ}_{HV} - σ}{\vert {ϕ}_{4} - {δ}_{HV} \vert + σ} + 1 ] \times ( {δ}_{HV} + {ϕ}_{5} ) + \frac{1}{4} [ \frac{{δ}_{HV} - {ϕ}_{4} + σ}{\vert {δ}_{HV} - {ϕ}_{4} \vert + σ} ] \times [ \frac{2 π - {δ}_{HV} - σ}{\vert 2 π - {δ}_{HV} \vert + σ} + 1 ] \times ( {δ}_{HV} - {ϕ}_{4} )$$

### Maximum Remote Vehicle Heading Angle

$${δ}_{{RV}_{max L}}^{11} = \frac{1}{4} [ \frac{{δ}_{HV} - 0 + σ}{\vert {δ}_{HV} - 0 \vert + σ} + 1 ] \times [ \frac{{ϕ}_{5} - {δ}_{HV} - σ}{\vert {ϕ}_{5} - {δ}_{HV} \vert + σ} + 1 ] \times ( {δ}_{HV} + {ϕ}_{4} ) + \frac{1}{4} [ \frac{{δ}_{HV} - {ϕ}_{5} + σ}{\vert {δ}_{HV} - {ϕ}_{5} \vert + σ} ] \times [ \frac{2 π - {δ}_{HV} - σ}{\vert 2 π - {δ}_{HV} \vert + σ} + 1 ] \times ( {δ}_{HV} - {ϕ}_{5} )$$

$${δ}_{{RV}_{max R}}^{11} = \frac{1}{4} [ \frac{{δ}_{HV} - 0 + σ}{\vert {δ}_{HV} - 0 \vert + σ} + 1 ] \times [ \frac{{ϕ}_{3} - {δ}_{HV} - σ}{\vert {ϕ}_{3} - {δ}_{HV} \vert + σ} + 1 ] \times ( {δ}_{HV} + {ϕ}_{6} ) + \frac{1}{4} [ \frac{{δ}_{HV} - {ϕ}_{3} + σ}{\vert {δ}_{HV} - {ϕ}_{3} \vert + σ} ] \times [ \frac{2 π - {δ}_{HV} - σ}{\vert 2 π - {δ}_{HV} \vert + σ} + 1 ] \times ( {δ}_{HV} - {ϕ}_{3} )$$

### Where:

φ₃=π/2−φ_{L}

φ₄=π/2+φ_{L}

φ₅=3π/2−φ_{R}

φ₆=3π/2+φ_{R}

φ_{L} and φ_{R} are threshold values that defines the angular range in which the remote vehicle 14 is defined to be in a crossing path with the host vehicle 10.

These variables define the minimum and maximum boundaries for the range of δ_{remote vehicle} with respect to δ_{host vehicle} for crossing paths values of S, emote vehicle that fall outside these ranges are considered to be another condition such as in-path, opposite path or diverging path. The direction, left or right, from which the remote vehicle 14 is approaching is immaterial but a single equation for δ_{RV}_{ₘᵢₙ}¹¹ and δ_{RV}_{ₘᵢₙ}¹¹ is desired. This can be achieved by the following two equations:

$${δ}_{{RV}_{min}}^{11} = {δ}_{{RV}_{min L}}^{11} \times \frac{1}{2} [ \frac{{L}_{{Q}_{1}} + {L}_{{Q}_{2}} - σ}{\vert {L}_{{Q}_{1}} + {L}_{{Q}_{2}} \vert + σ} + 1 ] + {δ}_{{RV}_{min R}}^{11} \times \frac{1}{2} [ \frac{{R}_{{Q}_{1}} + {R}_{{Q}_{2}} - σ}{\vert {R}_{{Q}_{1}} + {R}_{{Q}_{2}} \vert + σ} + 1 ]$$

$${δ}_{{RV}_{max}}^{11} = {δ}_{{RV}_{max L}}^{11} \times \frac{1}{2} [ \frac{{L}_{{Q}_{1}} + {L}_{{Q}_{2}} - σ}{\vert {L}_{{Q}_{1}} + {L}_{{Q}_{2}} \vert + σ} + 1 ] + {δ}_{{RV}_{max R}}^{11} \times \frac{1}{2} [ \frac{{R}_{{Q}_{1}} + {R}_{{Q}_{2}} - σ}{\vert {R}_{{Q}_{1}} + {R}_{{Q}_{2}} \vert + σ} + 1 ]$$

### Where

$${L}_{{Q}_{1}} = {L}_{{Q}_{4}} = \frac{1}{4} [ \frac{{δ}_{HV} - {A}_{6} + σ}{\vert {δ}_{HV} - {A}_{6} \vert + σ} + 1 ] \times [ \frac{{A}_{7} - {δ}_{HV} - σ}{\vert {A}_{7} - {δ}_{HV} \vert + σ} + 1 ]$$

$${L}_{{Q}_{2}} = {L}_{{Q}_{3}} = \frac{1}{4} [ \frac{{δ}_{HV} - 0 + σ}{\vert {δ}_{HV} - 0 \vert + σ} + 1 ] \times [ \frac{{A}_{13} - {δ}_{HV} - σ}{\vert {A}_{13} - {δ}_{HV} \vert + σ} + 1 ] + \frac{1}{4} [ \frac{{δ}_{HV} - {A}_{16} + σ}{\vert {δ}_{HV} - {A}_{16} \vert + σ} + 1 ] \times [ \frac{2 π - {δ}_{HV} - σ}{\vert 2 π - {δ}_{HV} \vert + σ} + 1 ] \\ {R}_{{Q}_{1}} = {R}_{{Q}_{4}} = \frac{1}{4} [ \frac{{δ}_{HV} - 0 + σ}{\vert {δ}_{HV} - 0 \vert + σ} + 1 ] \times [ \frac{{A}_{5} - {δ}_{HV} - σ}{\vert {A}_{5} - {δ}_{HV} \vert + σ} + 1 ] + \frac{1}{4} [ \frac{{δ}_{HV} - {A}_{8} + σ}{\vert {δ}_{HV} - {A}_{8} \vert + σ} + 1 ] \times [ \frac{2 π - {δ}_{HV} - σ}{\vert 2 π - {δ}_{HV} \vert + σ} + 1 ] \\ {R}_{{Q}_{2}} = {R}_{{Q}_{3}} = \frac{1}{4} [ \frac{{δ}_{HV} - {A}_{14} + σ}{\vert {δ}_{HV} - {A}_{14} \vert + σ} + 1 ] \times [ \frac{{A}_{15} - {δ}_{HV} - σ}{\vert {A}_{15} - {δ}_{HV} \vert + σ} + 1 ]$$

And:

A₅=β₁−φ₂
A₆=β₁+φ₂
A₇=β₁+π−φ₂
A₈=β₁+π+φ₂
A₁₃=β₁−π−φ₂
A₁₄=β₁−π+φ₂
A₁₅=β₁−φ₂
A₁₆=β₁+β₂

The remote vehicle 14 is considered to be in a crossing path with the host vehicle 10 when the heading angle of the remote vehicle 14, δ_{remote vehicle} falls within the range δ_{RV}_{ₘᵢₙ}¹¹ and δ_{RV}_{ₘₐₓ}¹¹ as defined above. When the remote vehicle 14 is approaching from the left, there are three regions that need to be considered:

$$0 \leq {δ}_{HV} < 3 π \text{/} 2 - {ϕ}_{L} \to \{ \begin{matrix}{δ}_{HV} < {δ}_{{RV}_{min}}^{11} \\ {δ}_{HV} < {δ}_{{RV}_{max}}^{11}\end{matrix} \\ 3 π \text{/} 2 - {ϕ}_{L} \leq {δ}_{HV} < 3 π \text{/} 2 + {ϕ}_{L} \to \{ \begin{matrix}{δ}_{HV} < {δ}_{{RV}_{min}}^{11} \\ {δ}_{HV} > {δ}_{{RV}_{max}}^{11}\end{matrix} \\ 3 π \text{/} 2 + {ϕ}_{L} \leq {δ}_{HV} < 2 π \to \{ \begin{matrix}{δ}_{HV} > {δ}_{{RV}_{min}}^{11} \\ {δ}_{HV} > {δ}_{{RV}_{max}}^{11}\end{matrix}$$

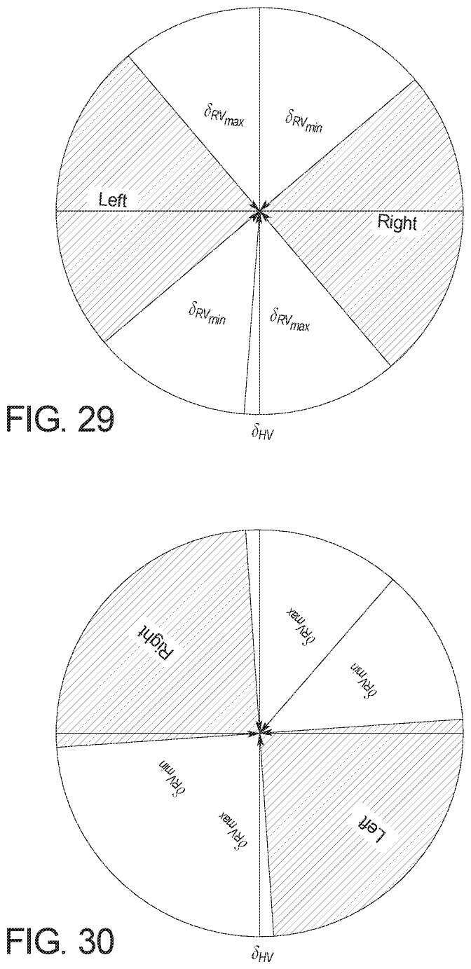

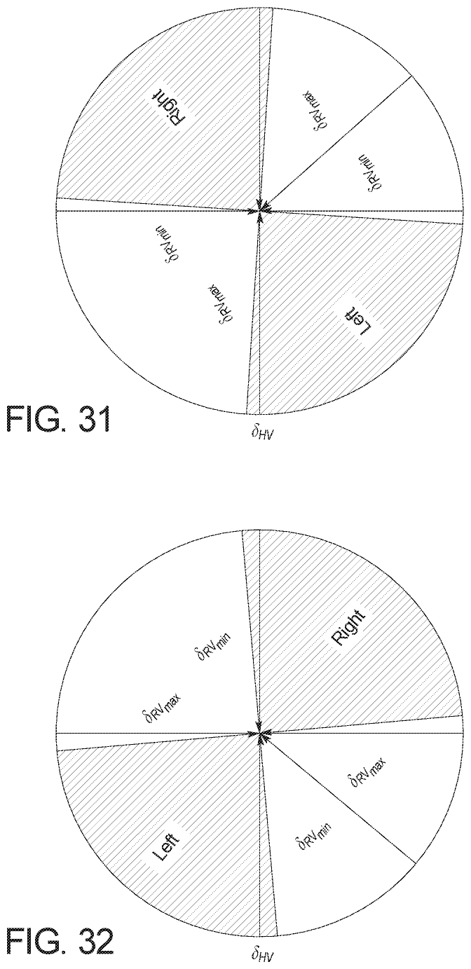

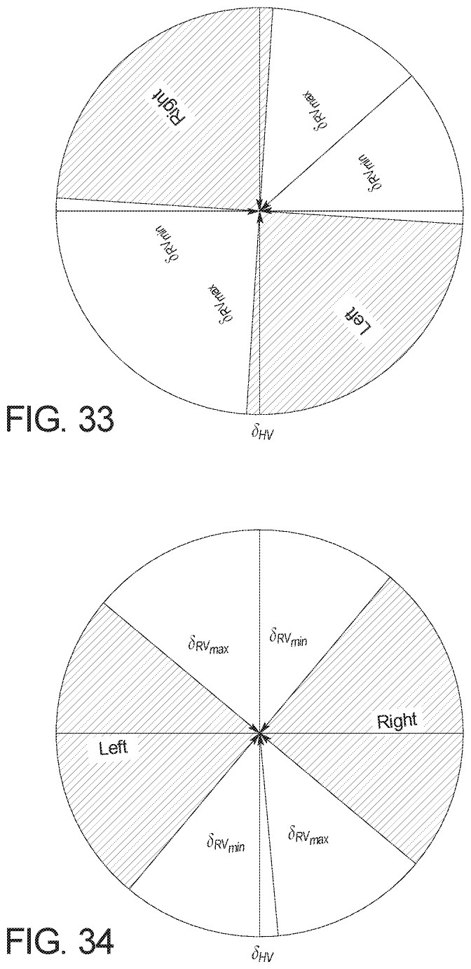

These regions are illustrated in FIGS. 29-34.

Similarly, when the remote vehicle 14 is approaching from the right, there are three regions that need to be considered:

$$0 \leq {δ}_{HV} < π \text{/} 2 - {ϕ}_{R} \to \{ \begin{matrix}{δ}_{HV} < {δ}_{{RV}_{min}}^{11} \\ {δ}_{HV} < {δ}_{{RV}_{max}}^{11}\end{matrix} \\ π \text{/} 2 - {ϕ}_{R} \leq {δ}_{HV} < π \text{/} 2 + {ϕ}_{R} \to \{ \begin{matrix}{δ}_{HV} < {δ}_{{RV}_{min}}^{11} \\ {δ}_{HV} > {δ}_{{RV}_{max}}^{11}\end{matrix} \\ π \text{/} 2 + {ϕ}_{R} \leq {δ}_{HV} < 2 π \to \{ \begin{matrix}{δ}_{HV} > {δ}_{{RV}_{min}}^{11} \\ {δ}_{HV} > {δ}_{{RV}_{max}}^{11}\end{matrix}$$

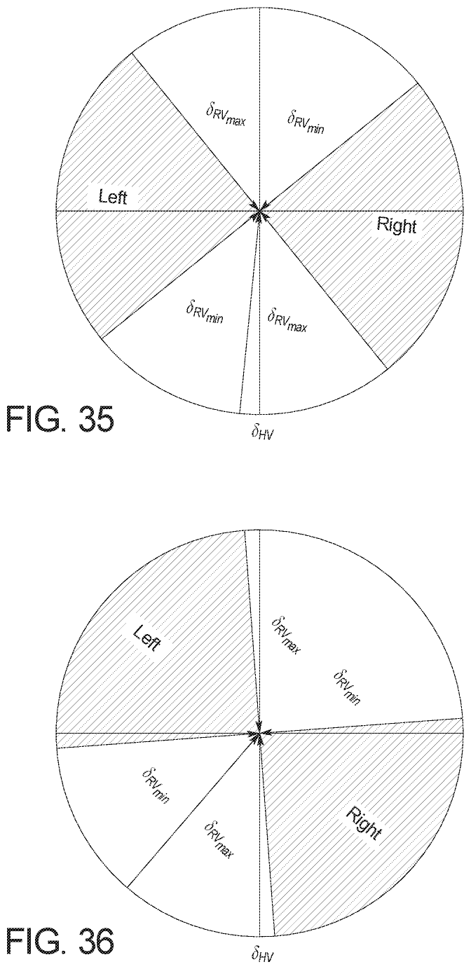

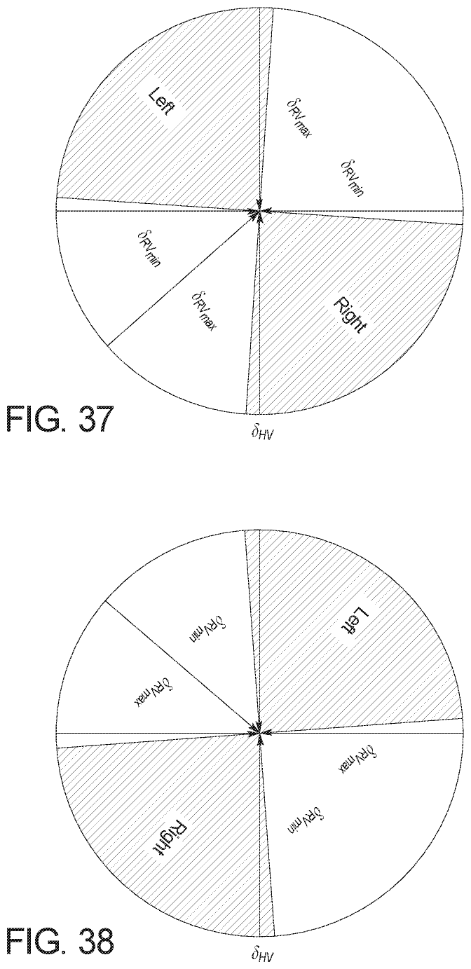

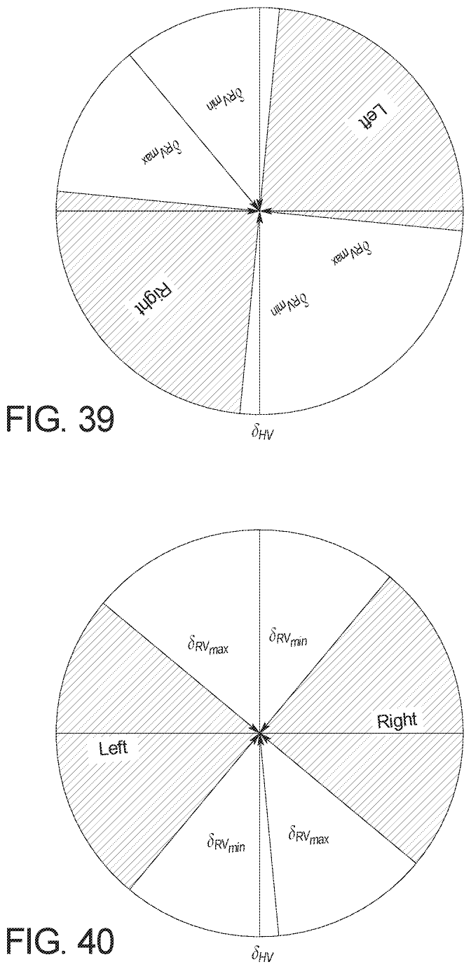

These regions are illustrated in FIGS. 35-40.

Consider the following expressions for H₁ and H₂.

H₁=δ_{HV}−δ_{RV}_{ₘᵢₙ}¹¹

H₂=δ_{HV}−δ_{RV}_{ₘₐₓ}¹¹

For any value of δ_{host vehicle}, the values for H₁ and H₂ fall within three distinct categories:

1: H₁ is negative, H₂ is negative and H₁>H₂
2: H₁ is negative, H₂ is positive and H₁<H₂
3: H₁ is positive, H₂ is positive and H₁>H₂

From these three conditions, it can be shown that for any combination of δ_{host vehicle} and δ_{remote vehicle}, where 0≤2π and 0≤δ_{RV}<2π the following expressions can be used to identify if the host vehicle 10 and remote vehicle 14 are crossing paths.

$${Δ}_{1}^{11} = \frac{1}{8} [ \frac{{δ}_{RV} - {δ}_{{RV}_{min}}^{11} + σ}{\vert {δ}_{RV} - {δ}_{{RV}_{min}}^{11} \vert + σ} + 1 ] \times [ \frac{{δ}_{{RV}_{max}}^{11} - {δ}_{RV} + σ}{\vert {δ}_{{RV}_{max}}^{11} - {δ}_{RV} \vert + σ} + 1 ] \times [ \frac{{H}_{1} - {H}_{2} - σ}{\vert {H}_{1} - {H}_{2} \vert + σ} + 1 ]$$

If H₁>H₂, δ_{RV}_{ₘᵢₙ}¹¹≤δ_{RV}<δ_{RV}_{ₘₐₓ}¹¹, Δ₁¹¹=1 otherwise Δ₁¹¹=0

$${Δ}_{2}^{11} = \frac{1}{8} [ \frac{{δ}_{{RV}_{min}}^{11} - {δ}_{RV} + σ}{\vert {δ}_{{RV}_{min}}^{11} - {δ}_{RV} \vert + σ} + 1 ] \times [ \frac{{δ}_{{RV}_{max}}^{11} - {δ}_{RV} + σ}{\vert {δ}_{{RV}_{max}}^{11} - {δ}_{RV} \vert + σ} + 1 ] \times [ 1 - \frac{{H}_{1} - {H}_{2} - σ}{\vert {H}_{1} - {H}_{2} \vert + σ} ]$$

If H₁<H₂, δ_{RV}_{ₘᵢₙ}¹¹≤δ_{RV} and δ_{RV}_{ₘₐₓ}¹¹≤δ_{RV}, Δ₂¹¹=1 otherwise Δ₂¹¹=0

$${Δ}_{3}^{11} = \frac{1}{8} [ \frac{{δ}_{RV} - {δ}_{{RV}_{min}}^{11} + σ}{\vert {δ}_{RV} - {δ}_{{RV}_{min}}^{11} \vert + σ} + 1 ] \times [ \frac{{δ}_{RV} - {δ}_{{RV}_{max}}^{11} + σ}{\vert {δ}_{RV} - {δ}_{{RV}_{max}}^{11} \vert + σ} + 1 ] \times [ 1 - \frac{{H}_{1} - {H}_{2} + σ}{\vert {H}_{1} - {H}_{2} \vert + σ} ]$$

If H₁<H₂, δ_{RV}_{ₘᵢₙ}¹¹≤δ_{RV} and δ_{RV}_{ₘₐₓ}¹¹≤δ_{RV}, Δ₃¹¹=1 otherwise Δ₃¹¹=0

Also, it is advantageous to define the difference of H₁ and H₂ as follows:

H₁−H₂=δ_{HV}−δ_{RV}_{ₘᵢₙ}¹¹−(δ_{HV}−δ_{RV}_{ₘₐₓ}¹¹)

H₁−H₂=δ_{HV}−δ_{RV}_{ₘᵢₙ}¹¹−δ_{HV}+δ_{RV}_{ₘₐₓ}¹¹

H₁−H₂=δ_{HV}−δ_{RV}_{ₘᵢₙ}¹¹−δ_{HV}+δ_{RV}_{ₘₐₓ}¹¹

H₁−H₂=δ_{RV}_{ₘₐₓ}¹¹−δ_{RV}_{ₘᵢₙ}¹¹

Then the expressions above can be expressed as:

$${Δ}_{1}^{11} = \frac{1}{8} [ \frac{{δ}_{RV} - {δ}_{{RV}_{min}}^{11} + σ}{\vert {δ}_{RV} - {δ}_{{RV}_{min}}^{11} \vert + σ} + 1 ] \times [ \frac{{δ}_{{RV}_{max}}^{11} - {δ}_{RV} + σ}{\vert {δ}_{{RV}_{max}}^{11} - {δ}_{RV} \vert + σ} + 1 ] \times [ \frac{{δ}_{{RV}_{max}}^{11} - {δ}_{{RV}_{min}}^{11} - σ}{\vert {δ}_{{RV}_{max}}^{11} - {δ}_{{RV}_{min}}^{11} \vert + σ} + 1 ] \\ {Δ}_{2}^{11} = \frac{1}{8} [ \frac{{δ}_{{RV}_{min}}^{11} - {δ}_{RV} + σ}{\vert {δ}_{{RV}_{min}}^{11} - {δ}_{RV} \vert + σ} + 1 ] \times [ \frac{{δ}_{{RV}_{max}}^{11} - {δ}_{RV} + σ}{\vert {δ}_{{RV}_{max}}^{11} - {δ}_{RV} \vert + σ} + 1 ] \times [ 1 - \frac{{δ}_{{RV}_{max}}^{11} - {δ}_{{RV}_{min}}^{11} + σ}{\vert {δ}_{{RV}_{max}}^{11} - {δ}_{{RV}_{min}}^{11} \vert + σ} ] \\ {Δ}_{3}^{11} = \frac{1}{8} [ \frac{{δ}_{RV} - {δ}_{{RV}_{min}}^{11} + σ}{\vert {δ}_{RV} - {δ}_{{RV}_{min}}^{11} \vert + σ} + 1 ] \times [ \frac{{δ}_{RV} - {δ}_{{RV}_{max}}^{11} + σ}{\vert {δ}_{RV} - {δ}_{{RV}_{max}}^{11} \vert + σ} + 1 ] \times [ 1 - \frac{{δ}_{{RV}_{max}}^{11} - {δ}_{{RV}_{min}}^{11} + σ}{\vert {δ}_{{RV}_{max}}^{11} - {δ}_{{RV}_{min}}^{11} \vert + σ} ]$$

By summing these three expressions, it can be determined that the host vehicle 10 and remote vehicle 14 are crossing paths if:

$${\sum }_{i = 1}^{3} {Δ}_{i}^{11} = 1 ( RQ = 11 )$$

### Thus:

$${r}_{3} = {\sum }_{i = 1}^{3} {Δ}_{i}^{11} \times 1$$

$${q}_{3} = {\sum }_{i = 1}^{3} {Δ}_{i}^{11} \times 1$$

### Finally:

$$R = {\sum }_{i = 1}^{3} {r}_{i}$$

$$Q = {\sum }_{i = 1}^{3} {q}_{i}$$

If R=Q=0 the paths of the remote vehicle 14 and host vehicle 10 are considered to be diverging away from each other.

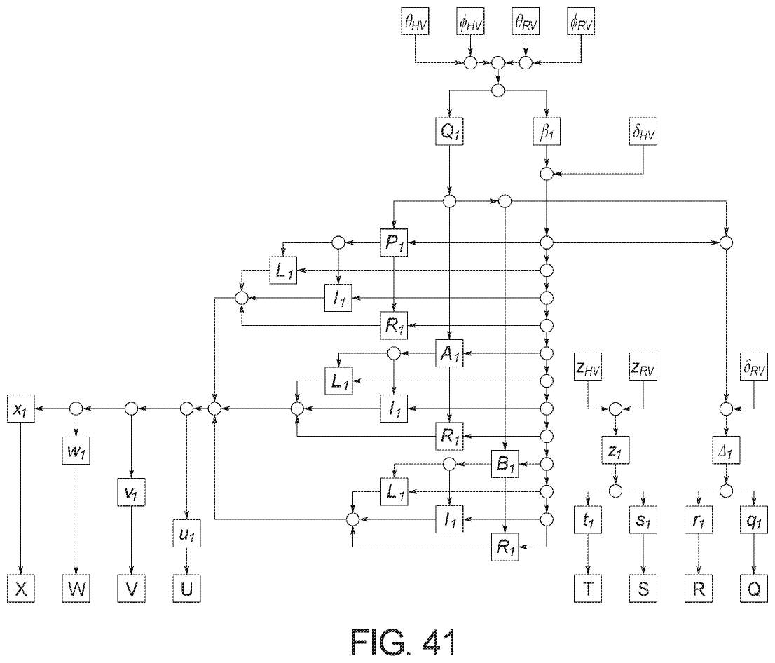

FIG. 41 identifies the interdependencies of the source data and expressions that are used to determine the values of the digits X through Q.

That is, the controller searches for the following series of relative position codes from a particular remote vehicle 14. If such a series of codes exists, the host vehicle 10 is being undertaken by the remote vehicle 14. Table 9 illustrates the relative position codes for identifying the host vehicle being undertaken.

TABLE 9

| X | W | V | U | T | S | R | Q |
|---|---|---|---|---|---|---|---|
| 1 | 0 | 1 | 0 | 0 | 0 | 0 | 1 |
| 0 | 0 | 1 | 0 | 0 | 0 | 0 | 1 |

The controller 24 first determines the jurisdictional requirements for the host vehicle 10 to determine if a warning or mitigation operation is appropriate. Once the laws of the current jurisdiction are determined, the controller 24 determines if a mitigation operation should be performed. When the system 12 determines that a remote vehicle 14 with a position code of 10100001 that is within a predetermined time, such as 3 seconds, from the host vehicle 10, the system 12 calculates the lateral distance of the remote vehicle 14 from the host vehicle 10. If the lateral distance is within 5.4 meters, the system 12 starts a timer 25 that is set to a predetermined value, such as 3 minutes. The system 12 uses the timer 25 to determine if a threshold number of remote vehicles 14, such as 3, undertakes the host vehicle 10 before the timer 25 times out. When the position code of a remote vehicle 14 undertaking the host vehicle 10 transitions from 10100001 to 00100001, the system 12 increments a counter 27, as long as the timer 25 has not run out. If the counter 27 value reaches a predetermined value, such as 3, before the timer 25 times out, the system 12 performs a mitigation operation, such as transitioning to a right lane or a lane to the right of the host vehicle 10. If the timer 25 runs out before the counter 27 reaches its predetermined value, the system 12 resets both timer 25 and counter 27 and does not perform a mitigation operation.

When the controller 24 detects a remote vehicle 14 with a position code of 10100001 that is within a predetermined time, such as 3 seconds, from the host vehicle 10, the system 12 determines the lateral distance of the remote vehicle 14 from the host vehicle 10. If the lateral distance is within 5.4 meters, the system 12 starts the timer 25, that is set to some predetermined value, such as 3 minutes. The system 12 uses the timer 25 to determine if a predetermined number of remote vehicles, such as 3, undertakes the host vehicle 10 before the timer 25 times out. When the position code of a remote vehicle 14 undertaking the host vehicle 10 transitions from 10100001 to 00100001, the system 12 increments the counter 27, as long as the timer 25 has not run out. If the counter value reaches a predetermined value, such as 3, before the timer 25 times out, the system 12 performs a mitigation operation, such as transitioning to a right lane or a lane to the right of the host vehicle 10. If the timer 25 runs out before the counter 27 reaches its predetermined value, the system 12 resets both timer 25 and counter 27 and does not perform a mitigation operation.

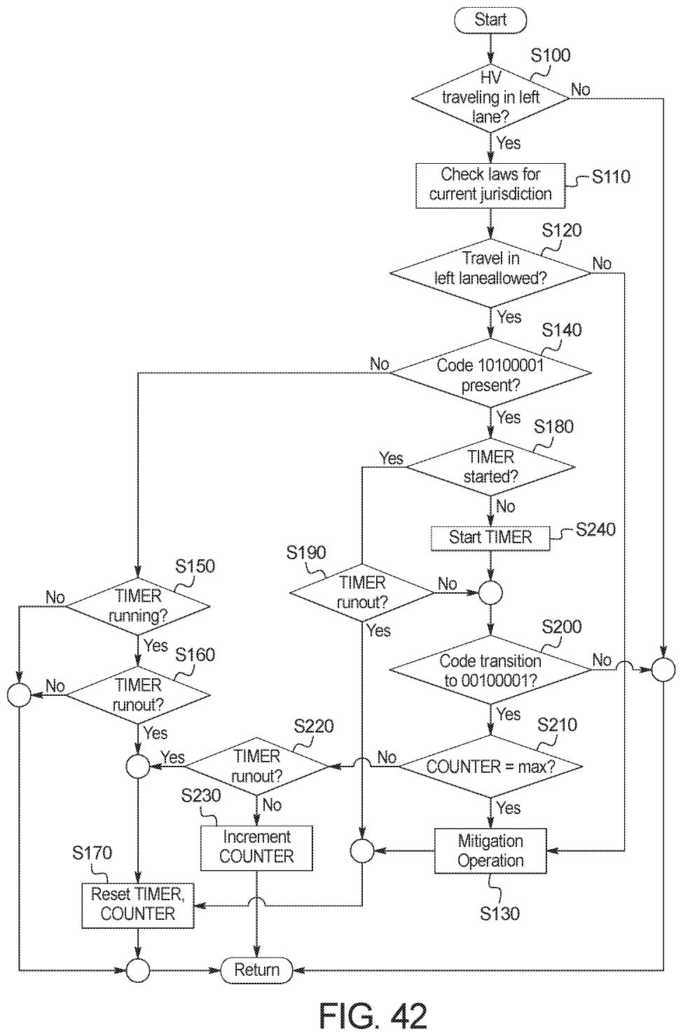

FIG. 42 illustrates a flow chart showing the process to determine whether a mitigation operation is necessary or warranted. It step S100, the controller 24 determines is the host vehicle 10 is traveling in the left lane or not in the right most lane. If the host vehicle 10 is not traveling in the left lane or is traveling in the right most lane, the controller 24 returns to start. If the host vehicle 10 is traveling in the left lane or is not traveling in the right most lane, the controller 24 checks for laws or rules for the current jurisdiction, in step S110. Based on the laws or rules for the current jurisdiction, the controller determines whether unrestricted travel is allowed in the left lane or in the non-right most lanes in step S120. If travel is not allowed in the left lane or non-right most lane, a mitigation operation is performed in step S130.

If travel is allowed in the left lane or non-right most lane, the controller 24 determines whether code 1010001 is present in step S140. If code 1010001 is not present, the controller 24 determines whether the timer 25 is running in step S150. If the timer 25 is not running, the controller 24 returns to start. If the timer 25 is running, the controller 24 determines whether the timer 25 has runout in step S160. If the timer 24 has not run out, the controller 24 returns to start. If the timer 25 has runout, the controller 24 resets the timer 25 and the counter 27 in step S170 and returns to start.

Turning back to step S140, if code 1010001 is present, the controller 24 determines whether the timer 25 has started in step S180. If the timer 25 has started, the controller 24 determines whether the timer 25 has runout in step S190. If the timer 25 has runout, the controller 24 resets the timer 25 and the counter 270 in step S170 and returns to start. If the timer 25 has not run out, the controller 24 determines whether the remote vehicles 14 have transitioned to code 0010001 in step S200. If the remote vehicles 14 have not transitioned to code 0010001, the controller 24 returns to start. If the controller 24 determines that the remote vehicles 14 have transitioned to code 00100001, the controller 24 determines whether the counter 27 has reached a predetermined number of maximum remote vehicles 14 in step S210. If the counter 27 has reached a predetermined number of maximum remote vehicles 14, the controller 24 instructs the system 24 to perform a mitigation operation in step S130.

If the counter 27 has not reached a predetermined number of maximum remote vehicles 14, the controller 24 determines whether the timer 25 has run out in step S220. If the timer 25 has runout, the controller 24 resets the timer 25 and the counter 27 in step S170 and returns to start. If the controller 24 determines that the timer 25 has not runout, the controller 24 increments the counter 27 in step S230 and returns to start.

Turning back to step S180, if the timer 25 has not started, the controller 24 starts the timer in S240. The controller 24 then determines whether the remote vehicles 14 have transitioned to code 0010001 in step S200. If the remote vehicles 14 have not transitioned to code 0010001, the controller 24 returns to start. If the controller 24 determines that the remote vehicles 14 have transitioned to code 00100001, the controller 24 determines whether the counter 27 has reached a predetermined number of maximum remote vehicles 14 in step S210. If the counter 27 has reached a predetermined number of maximum remote vehicles 14, the controller 24 instructs the system 12 to perform a mitigation operation in step S130.

If the counter 27 has not reached a predetermined number of maximum remote vehicles 14, the controller 24 determines whether the timer 25 has run out in step S220. If the timer 25 has runout, the controller 24 resets the timer 25 and the counter 27 in step S170 and returns to start. If the controller 24 determines that the timer 25 has not runout, the controller 24 increments the counter 27 in step S230 and returns to start.

It has been found that the present system improve vehicles and vehicle occupant safety, improves compliance with local jurisdictional laws and rules by performing a mitigation operation when determining the appropriate a lane for a vehicle.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “section,” “portion,” or “element” when used in the singular can have the dual meaning of a single part or a plurality of parts. Also as used herein to describe the above embodiment(s), the following directional terms “forward”, “rear”, “vertical” and “horizontal”, as well as any other similar directional terms refer to those directions of a vehicle equipped with the system for determining a lane for a vehicle. Accordingly, these terms, as utilized to describe the present invention should be interpreted relative to a vehicle equipped with the system for determining a lane for a vehicle.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A system for determining a lane for a vehicle, the system comprising:
a receiver configured to receive information related to a remote vehicle, the information including a remote vehicle location, a remote vehicle speed and a remote vehicle travel path; and
an electronic controller configured to determine a host vehicle location, a host vehicle speed and a host vehicle travel path, compare the host vehicle location with the remote vehicle location, compare the host vehicle speed with the remote vehicle speed and compare the host vehicle travel path with the remote vehicle travel path, and cause the host vehicle to perform a mitigation operation when the electronic controller determines that the remote vehicle location, the remote vehicle speed and the remote vehicle travel path indicate that the remote vehicle must pass or has passed the host vehicle on a right side.

2. The system according to claim 1, wherein
the electronic controller is configured to determine a distance between the host vehicle and the remote vehicle, and configured to perform the mitigation operation when the distance between the remote vehicle and the host vehicle is decreasing.

3. The system according to claim 1, wherein
the receiver is configured to receive the information related to the remote vehicle by vehicle to vehicle communications.

4. The system of claim 1, wherein
the remote vehicle information includes information representing a lateral distance of the remote vehicle from the host vehicle.

5. The system of claim 1, wherein
the mitigation device is configured to perform at least one of the following mitigation operations: issue a visual warning, issue a warning sound, cause the host vehicle to change lanes, and cause a tactile sensation within the host vehicle.

6. The system for determining a lane for a vehicle of claim 1, further comprising
a transmitter configured to transmit a signal to the remote vehicle indicating that the host vehicle is changing lanes.

7. The system according to claim 1, further comprising at least one sensor configured to detect the presence of the remote vehicle.

8. The system according to claim 1, wherein
the electronic controller is configured to determine jurisdictional requirements based on the location of the host vehicle and configured to perform the mitigation operation based on the jurisdictional requirements.

9. The system according to claim 1, wherein
the electronic controller is configured to determine a number of lanes on a road based on the host vehicle location.

10. The system according to claim 1, wherein
the electronic controller is configured to determine the travel path of the remote vehicle based on a plurality of position coordinates received by the receiver within a predetermined amount of time.

11. The system according to claim 10, wherein
the electronic controller is configured to compare the plurality of position coordinates received by the receiver with host vehicle position coordinates to determine whether the travel path of the host vehicle and the travel path of the remote vehicle are the same.

12. A method for determining a lane for a vehicle, the method comprising:
operating a receiver to receive information related to a remote vehicle, the information including a remote vehicle location, a remote vehicle speed and a remote vehicle travel path;
determining by an electronic controller a host vehicle location, a host vehicle speed and a host vehicle travel path;
comparing with the electronic controller the host vehicle location with the remote vehicle location, comparing the host vehicle speed with the remote vehicle speed and comparing the host vehicle travel path with the remote vehicle travel path; and
causing with the controller the host vehicle to perform a mitigation operation when the electronic controller determines that the remote vehicle location, the remote vehicle speed and the remote vehicle travel path indicate that the remote vehicle must pass or has passed the host vehicle on a right side.

13. The method of claim 12, wherein
the remote vehicle information includes information representing a lateral distance of the remote vehicle from the host vehicle.

14. The method of claim 12, wherein
causing with the controller the host vehicle to perform the mitigation operation includes at least one of the following mitigation operations: issuing a visual warning, issuing a warning sound, causing the host vehicle to change lanes, and causing a tactile sensation within the host vehicle.

15. The method of claim 12, further comprising operating a transmitter transmit a signal to the remote vehicle indicating that the host vehicle is changing lanes.

16. The method according to claim 12, further comprising operating at least one sensor configured to detect the presence of the remote vehicle.

17. The method according to claim 12, further comprising
determining with the electronic controller jurisdictional requirements based on the location of the host vehicle and performing the mitigation operation based on the jurisdictional requirements.

18. The method according to claim 12, further comprising
determining with the electronic controller a number of lanes on a road based on the host vehicle location.

19. The method according to claim 12, further comprising
determining with the electronic controller the travel path of the remote vehicle based on a plurality of position coordinates received by the receiver within a predetermined amount of time.

20. The method according to claim 19, further comprising
comparing with the electronic controller the plurality of position coordinates received by the receiver with host vehicle position coordinates and determining whether the travel path of the host vehicle and the travel path of the remote vehicle are the same.
